(19) United States
(12) Patent Application Publication
(10) Pub. No.: US 2007/0140822 A1
(43) Pub. Date: Jun. 21, 2007

(54) METHODS AND APPARATUS FOR OPENING AND CLOSING SUBSTRATE CARRIERS

(75) Inventors: Martin R. Elliott, Pepperell, MA (US); Jeffrey C. Hudgens, San Francisco, CA (US); Vinay K. Shah, San Mateo, CA (US)

Correspondence Address: DUGAN & DUGAN, PC, 55 SOUTH BROADWAY, TARRYTOWN, NY, 10591, US

(73) Assignee: APPLIED MATERIALS, INC.

(21) Appl. No.: 11/554,439

(22) Filed: Oct. 30, 2006

Related U.S. Application Data
(60) Provisional application No. 60/751,085, filed on Dec. 16, 2005.

(51) Int. Cl. B65B 69/00; B66F 11/00

(52) U.S. Cl. 414/684.3; 414/411; 414/416.01

(57) ABSTRACT

The invention provides methods, systems and apparatus for opening a substrate carrier. The invention provides a novel loadport for receiving a substrate carrier from a substrate carrier transport system. The loadport includes a door opening mechanism adapted use vacuum pressure to hold a substrate carrier door against the door opening mechanism. The loadport is further adapted to apply a gas flow to the periphery of the substrate carrier to block potential contaminants from entering the substrate carrier. Numerous other features are provided.

The present application claims priority to U.S. Provisional Patent Application Ser. No. 60/751,085, filed Dec. 16, 2005 and titled “SMALL LOT SIZE SUBSTRATE CARRIERS” (Attorney Docket No. 9604/L/SYNX/SYNX), which is hereby incorporated by reference herein in its entirety.

### RELATED APPLICATIONS

The present application is related to the following commonly-assigned United States Patent Applications, each of which is hereby incorporated by reference herein in its entirety:

U.S. Provisional Patent Application Ser. No. 60/738,542, filed on Nov. 21, 2005 and entitled “APPARATUS AND METHODS FOR A SUBSTRATE CARRIER HAVING AN INFLATABLE SEAL” (Attorney Docket No. 9611);
U.S. Provisional Patent Application Ser. No. 60/542,519, filed Feb. 5, 2004 and titled “SMALL LOT SIZE SUBSTRATE CARRIERS” (Attorney Docket No. 8827/L2/JB);
U.S. patent application Ser. No. 10/764,820, filed Jan. 26, 2004 and titled “OVERHEAD TRANSFER FLANGE AND SUPPORT FOR SUSPENDING A SUBSTRATE CARRIER” (Attorney Docket No. 8092);
U.S. provisional application Ser. No. 60/443,153, filed Jan. 27, 2003 and titled “OVERHEAD TRANSFER FLANGE AND SUPPORT FOR SUSPENDING WAFER CARRIER” (Attorney Docket No. 8092/L);
U.S. patent application Ser. No. 10/650,310, filed Aug. 28, 2003 and titled “System For Transporting Substrate Carriers” (Attorney Docket No. 6900);
U.S. patent application Ser. No. 10/650,312, filed Aug. 28, 2003 and titled “Method and Apparatus for Using Substrate Carrier Movement to Actuate Substrate Carrier Door Opening/Closing” (Attorney Docket No. 6976);
U.S. patent application Ser. No. 10/650,481, filed Aug. 28, 2003 and titled “Method and Apparatus for Unloading Substrate Carriers from Substrate Carrier Transport Systems” (Attorney Docket No. 7024);
U.S. patent application Ser. No. 10/650,479, filed Aug. 28, 2003 and titled “Method and Apparatus for Supplying Substrates to a Processing Tool” (Attorney Docket No. 7096);
U.S. Patent Application Ser. No. 60/407,452, filed Aug. 31, 2002 and titled “End Effector Having Mechanism For Reorienting A Wafer Carrier Between Vertical And Horizontal Orientations” (Attorney Docket No. 7097/L);
U.S. Patent Application Ser. No. 60/407,337, filed Aug. 31, 2002, and titled “Wafer Loading Station with Docking Grippers at Docking Stations” (Attorney Docket No. 7099/L);
U.S. patent application Ser. No. 10/650,311, filed Aug. 28, 2003 and titled “Substrate Carrier Door having Door Latching and Substrate Clamping Mechanism” (Attorney Docket No. 7156);
U.S. patent application Ser. No. 10/650,480, filed Aug. 28, 2003 and titled “Substrate Carrier Handler That Unloads Substrate Carriers Directly From a Moving Conveyor” (Attorney Docket No. 7676);
U.S. Provisional Application Ser. No. 60/443,087, filed Jan. 27, 2003 and titled “Methods and Apparatus for Transporting Wafer Carriers” (Attorney Docket No. 7163/L);
U.S. Provisional Application Ser. No. 60/443,001, filed Jan. 27, 2003, and titled “Systems and Methods for Transporting Wafer Carriers Between Processing Tools” (Attorney Docket No. 8201/L); and
U.S. Provisional Application Ser. No. 60/443,115, filed Jan. 27, 2003, and titled “Apparatus and Method for Storing and Loading Wafer Carriers” (Attorney Docket No. 8202/L).

### FIELD OF THE INVENTION

The present invention relates to electronic device manufacturing and, more particularly, to apparatus and methods related to opening and closing substrate carrier doors.

### BACKGROUND

It is generally preferable to protect substrates (e.g., patterned or unpatterned semiconductor wafers, glass panels, polymer substrates, reticules, masks, glass plates or the like) from exposure to any potential contaminating particles. Thus, such substrates may be stored in air tight containers. However, the substrates must typically be transported to different process tools within an electronic device manufacturing facility. Thus, what is needed are methods and apparatus for transporting substrates in sealed containers as well as systems and methods for accessing the substrates without exposing the substrates to potential contaminating particles.

### SUMMARY OF THE INVENTION

In a some aspects, the present invention provides a system for opening a substrate carrier that includes a substrate carrier adapted to hold one or more substrates; and a loadport for receiving a substrate carrier from a substrate carrier transport system, wherein the loadport includes a door opening mechanism, the door opening mechanism adapted use vacuum pressure to hold a substrate carrier door against the door opening mechanism.

In some other aspects, the present invention provides a method that includes receiving a substrate carrier at a loadport; aligning a door opener of the loadport with a door of the substrate carrier; and applying a vacuum pressure to the door via the door opener to hold the door.

In yet other aspects of the present invention, an apparatus for use with a substrate carrier is provided that includes a loadport including a door opening mechanism, wherein the door opening mechanism is adapted use vacuum pressure to hold a substrate carrier door against the door opening mechanism.

Other features and aspects of the present invention will become more fully apparent from the following detailed description, the appended claims and the accompanying drawings.

### BRIEF DESCRIPTION OF THE DRAWINGS

FIG. 1 is an exemplary embodiment of a substrate carrier having an overhead transfer flange and that is adapted to transport a single substrate;

FIGS. 2A-L illustrate a first exemplary embodiment of a door opening mechanism for opening the door of a substrate carrier;

FIGS. 3A-L illustrate a second exemplary embodiment of a door opening mechanism for opening the door of a substrate carrier;

FIGS. 4A-B illustrate a third exemplary embodiment of a door opening mechanism for opening the door of a substrate carrier;

FIGS. 5A-E illustrate a fourth exemplary embodiment of a door opening mechanism for opening the door of a substrate carrier;

FIGS. 6A-G illustrate various components of an exemplary substrate carrier;

FIGS. 7A-E illustrate an apparatus for storing a plurality of substrate carriers in accordance with an embodiment of the present invention;

FIGS. 8A-C illustrate an exemplary door for sealing a substrate carrier in accordance with an embodiment of the present invention;

FIGS. 9A-B illustrate isometric views of a front of a door opening mechanism in accordance with an embodiment of the present invention;

FIGS. 10A-B illustrate isometric views of a rear of the door opening mechanism in accordance with an embodiment of the present invention;

FIG. 11 is a cross-sectional side view of the door opening mechanism in accordance with an embodiment of the present invention; and

FIG. 12 is a cross-sectional side view of the door opening mechanism coupled to the door for sealing a substrate carrier in accordance with an embodiment of the present invention.

### DETAILED DESCRIPTION

The present invention provides a door opening mechanism that employs a vacuum for unlatching a substrate carrier door from remaining portions of the substrate carrier and/or for coupling the door opening mechanism to the door while opening the door. In some embodiments the periphery of the substrate carrier may be flushed with clean dry air or other non-contaminating gas (e.g., N₂) when the substrate carrier is opened in a loadport employing the door opening mechanism.

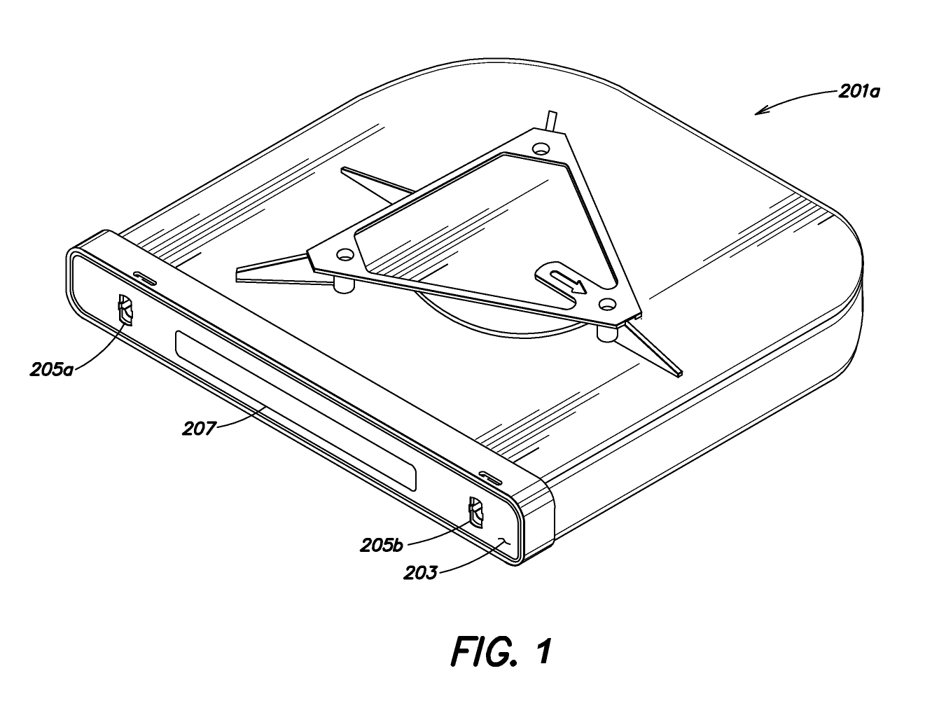

The figures and the following description thereof provide a specific configuration that embodies the inventive aspects identified above. Thus, the particular configuration of FIGS. 1-12, is merely exemplary and it will be understood that alternative configurations may be designed that function in accordance with the invention.

FIG. 1 is an exemplary embodiment of a substrate carrier 201a with an overhead transfer flange 113a and that is adapted to transport a single substrate. The present invention is applicable to substrate carriers that are adapted to hold two or more substrates as well. The substrate carrier 201a includes a door 203 that may be removed to allow access to a substrate stored within the substrate carrier 201a (as described further below). In the exemplary embodiment shown, the door 203 may include latches 205a,b that allow the door 203 to be selectively secured to and removed from the remainder of the substrate carrier 201a. The door 203 may include a region 207, such as a metallic or otherwise magnetic permeable region (e.g., iron, stainless steel, etc.), that allows the door 203 to be held securely by a door opening mechanism (described below) when access to an interior of the substrate carrier 201a is desired (e.g., for removing a substrate from or loading a substrate into the substrate carrier 201a). The remainder of the substrate carrier 201a may be fabricated from polycarbonate, Victrex® PEEK or another suitable material. Note that the height of a substrate carrier may be increased as the substrate capacity of the substrate carrier is increased.

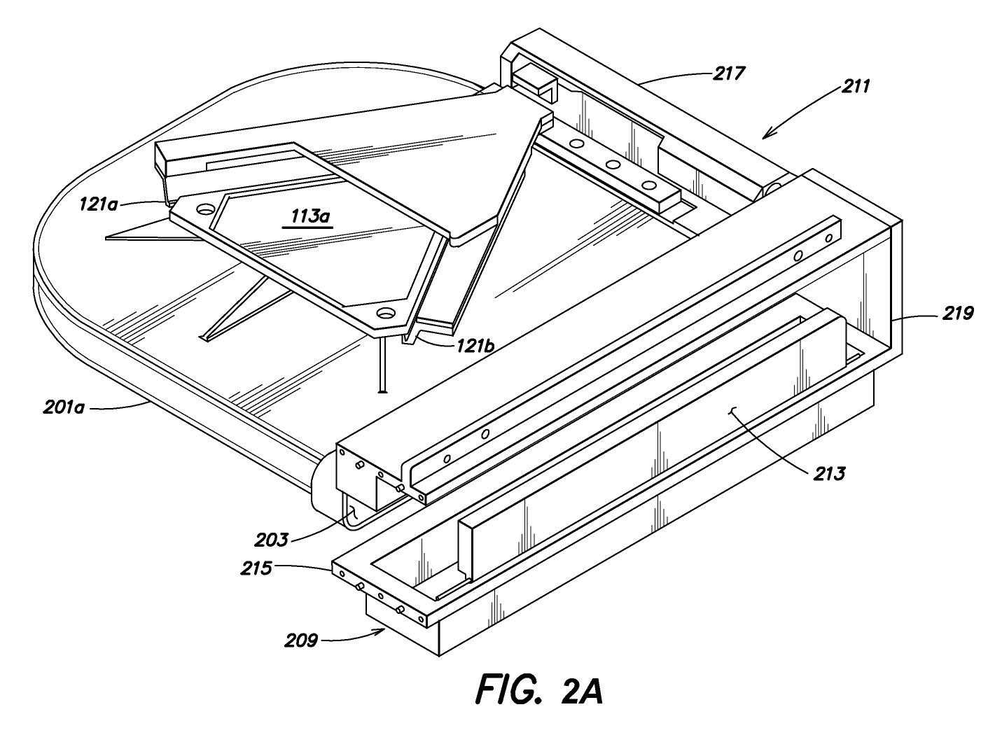

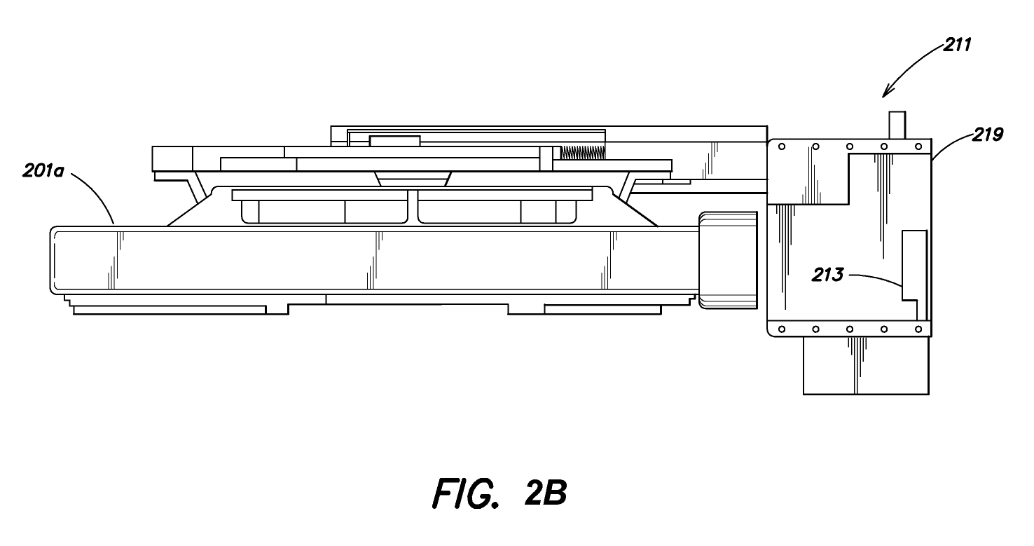

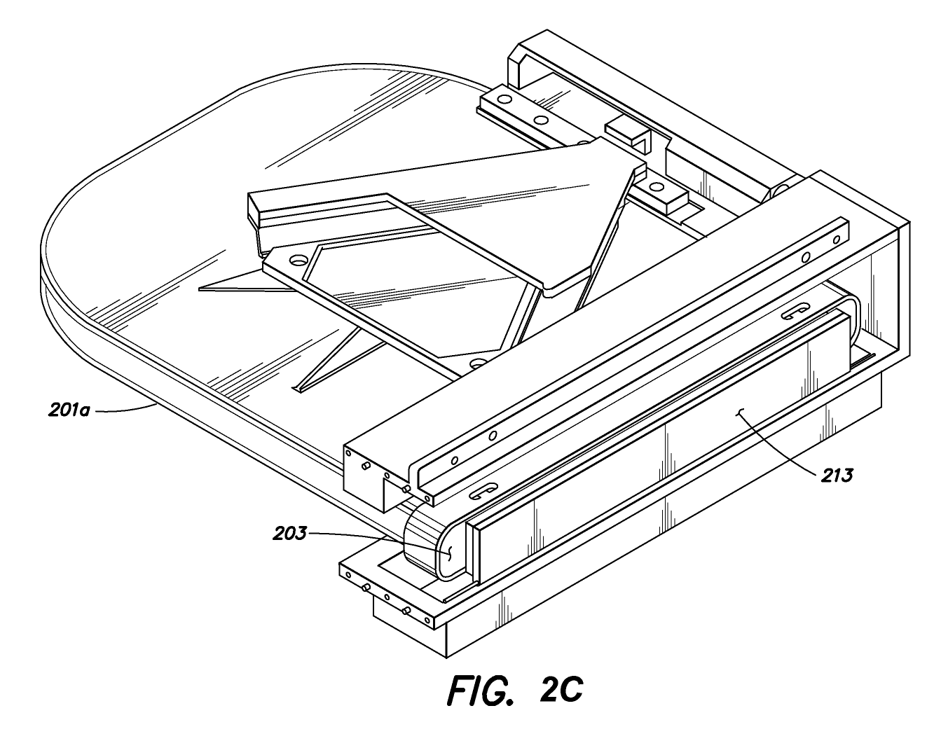

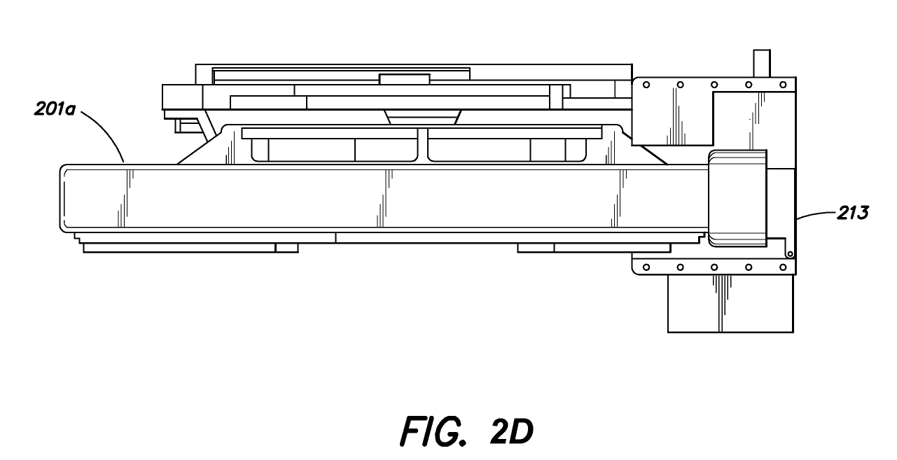

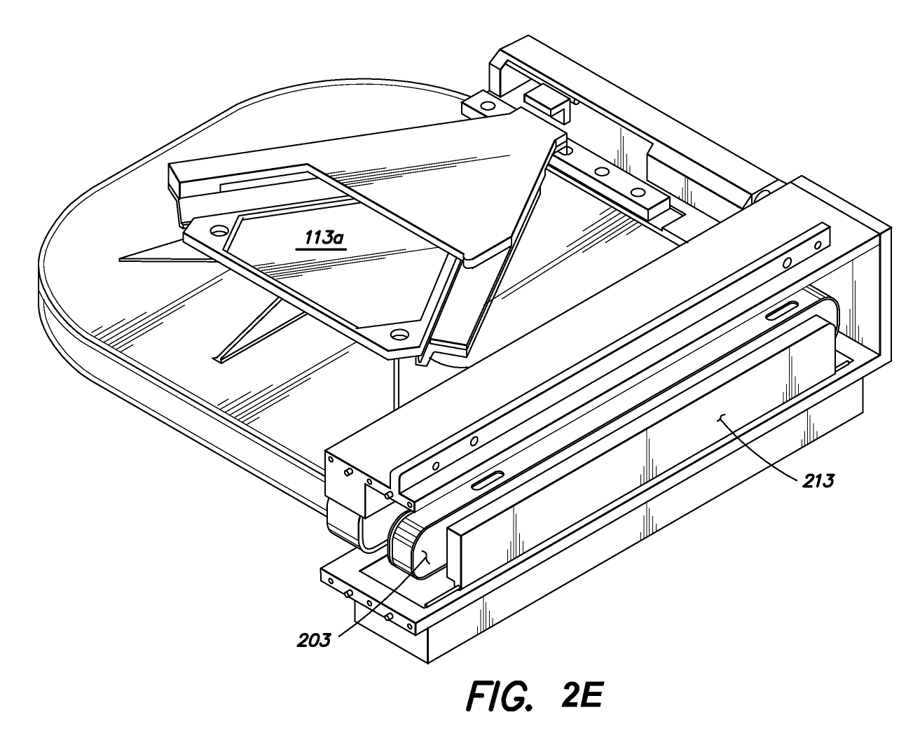

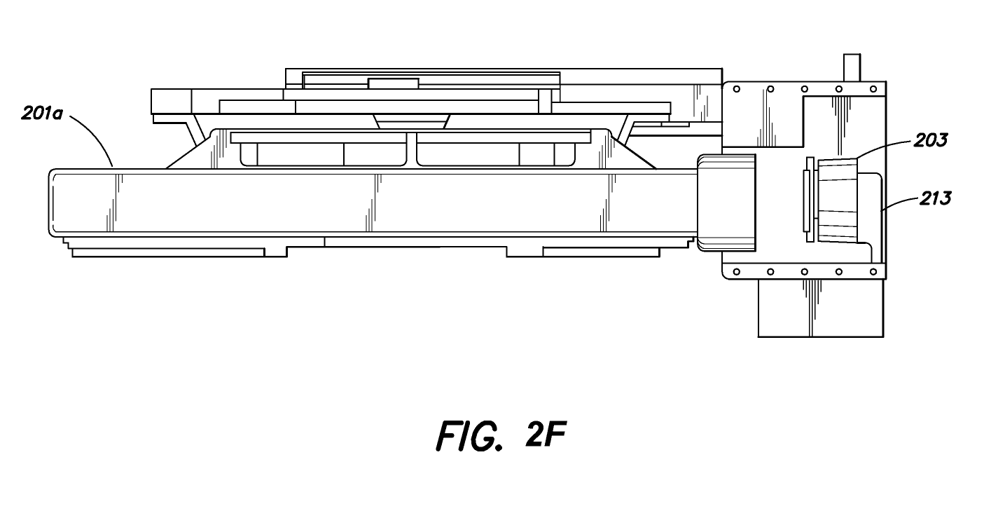

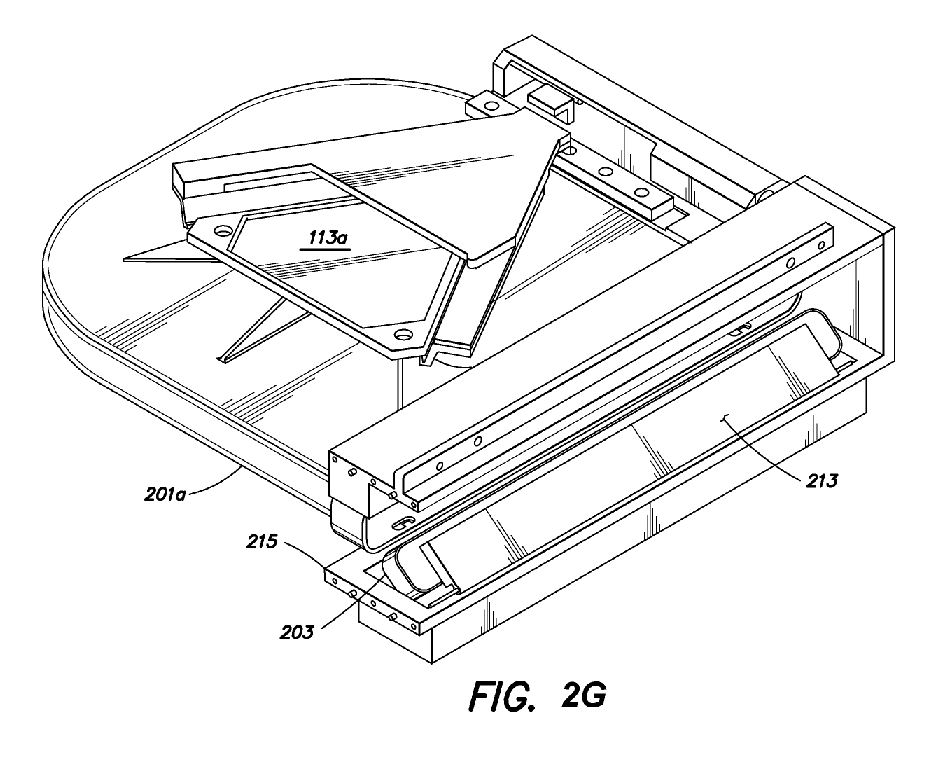

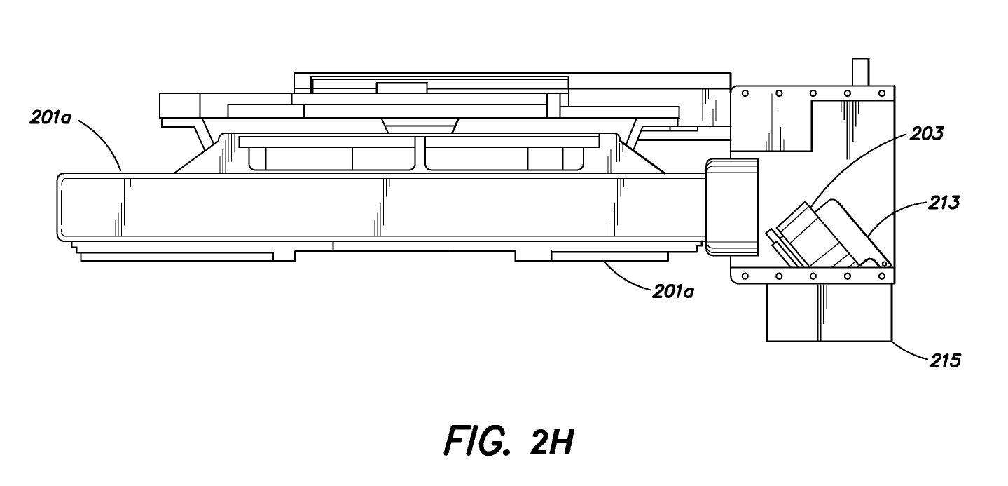

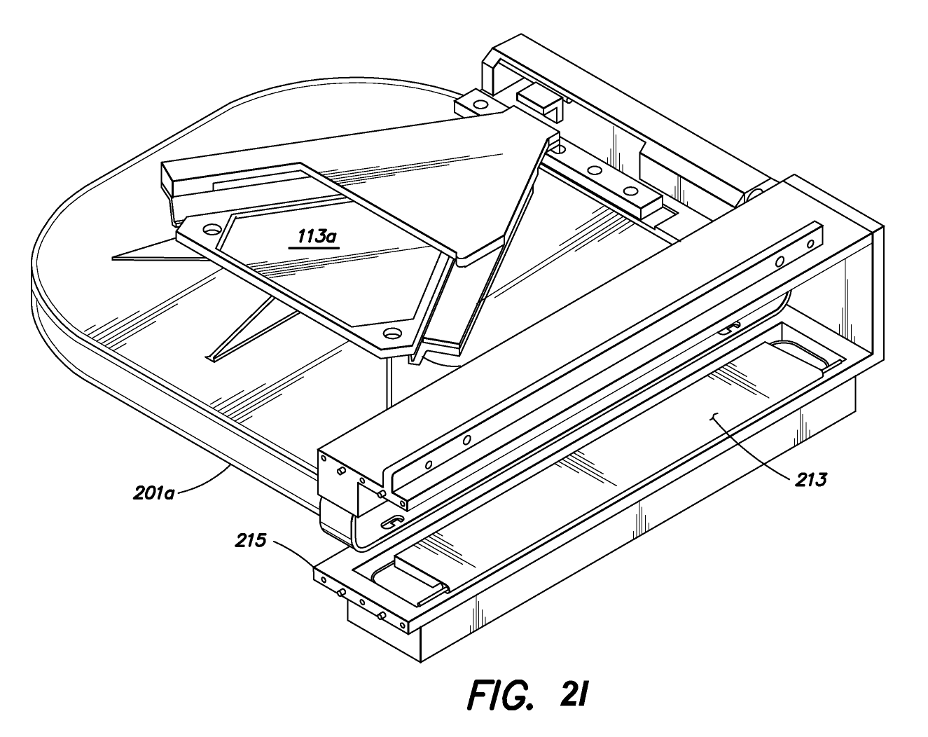

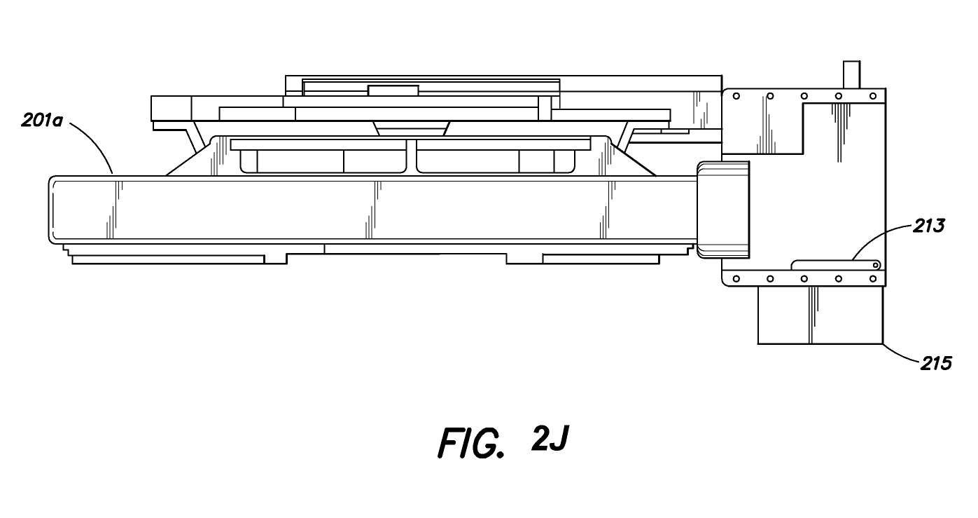

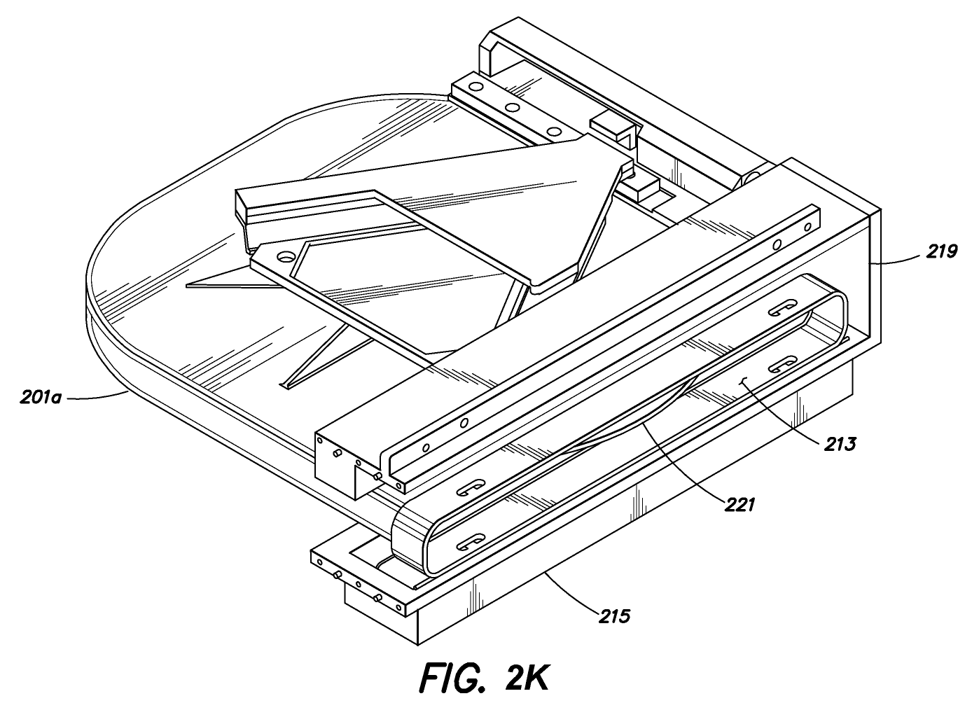

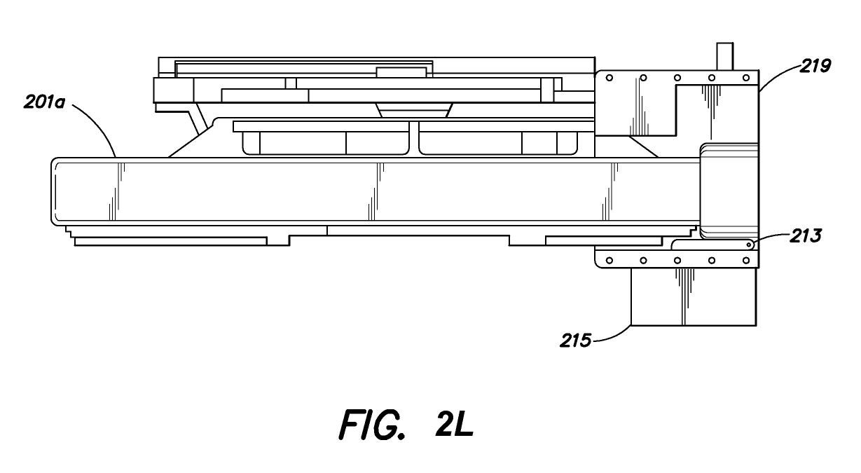

FIGS. 2A-L illustrate a first exemplary embodiment of a door opening mechanism 209 for opening the door 203 of the substrate carrier 201a. With reference to FIGS. 2A-L, the substrate carrier 201a is supported at a loadport location 211 using the blade receivers 121a, 121b and the overhead transfer flange 113a (e.g., allowing substrate carriers to be stacked with a high packing density). The door opening mechanism 209 includes a supporting member 213 that is adapted to contact and support the door 203 of the substrate carrier 201a, and pivot the door 203 below the remainder of the substrate carrier 201a (e.g., into a housing 215) as described further below. A linear actuator or other actuator 217 (e.g., a pneumatic, motor driven, etc., actuator) may be employed to dock/undock the substrate carrier relative to the door opening mechanism 209 and/or a loadport 219 of the loadport location 211.

In operation, the substrate carrier 201a is supported at the loadport location 211 by the blades 121a, 121b (via the overhead transfer flange 113a of the substrate carrier 201a) as shown in FIGS. 2A and 2B. The door 203 of the substrate carrier 201a is then moved toward and brought into contact with the supporting member 213 via the actuator 217 (FIGS. 2C-D). As will be described further below, the supporting member 213 may unlatch and support the door 203 in response to such docking motion.

Following unlatching of the door 203, the substrate carrier 201a is moved away from the loadport 219, leaving the door 203 supported by the supporting member 213 (FIGS. 2E-F). The supporting member 213 then is lowered (e.g., via an actuating mechanism not shown) into the housing 215 (FIGS. 2G-J). In this position, the door 203 is positioned below the substrate carrier 201a, and in the embodiment shown, in a substantially horizontal plane. Such an embodiment reduces the amount of space required to accommodate the door 203 (e.g., allowing closer loadport stacking). Once the door has been lowered, the substrate carrier 201b may be re-docked with the loadport 219 (e.g., to allow a substrate 221 to be removed therefrom) as shown in FIGS. 2K-L. Note that in the above configuration, the supporting member 213 is positioned above the door 203 and may protect the door 203 from being contaminated by particles generated during docking or undocking of the substrate carrier 201a. The supporting member 213 may be formed from any suitable material (e.g., a metal such as aluminum or the like).

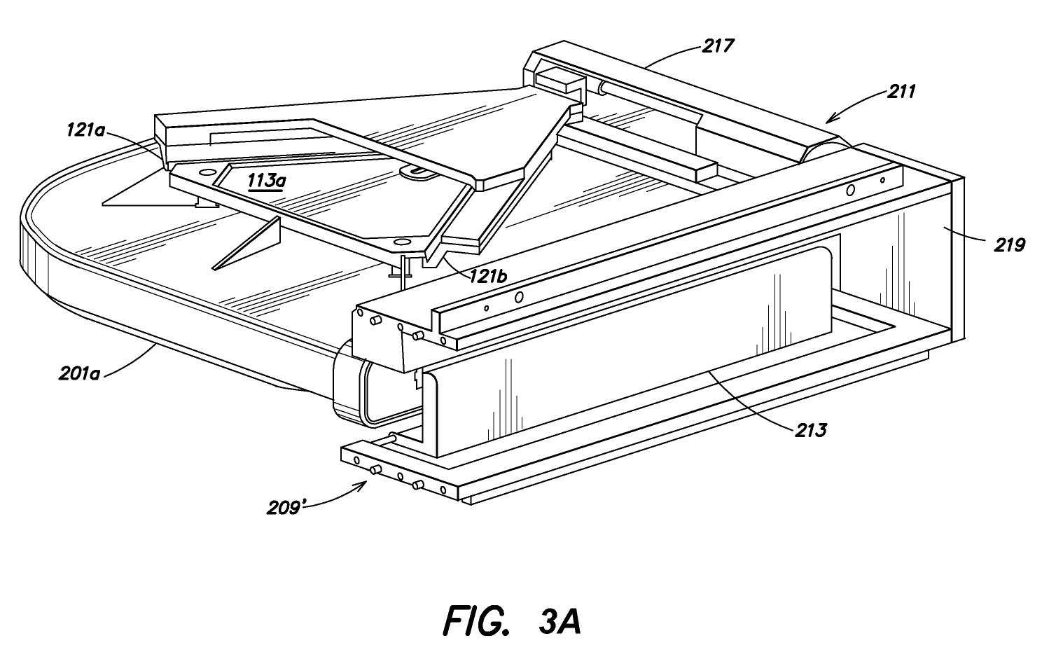

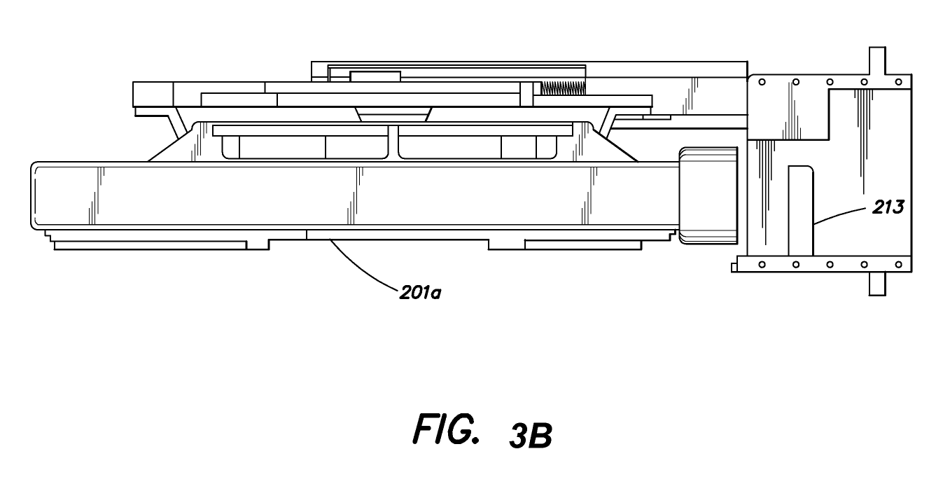

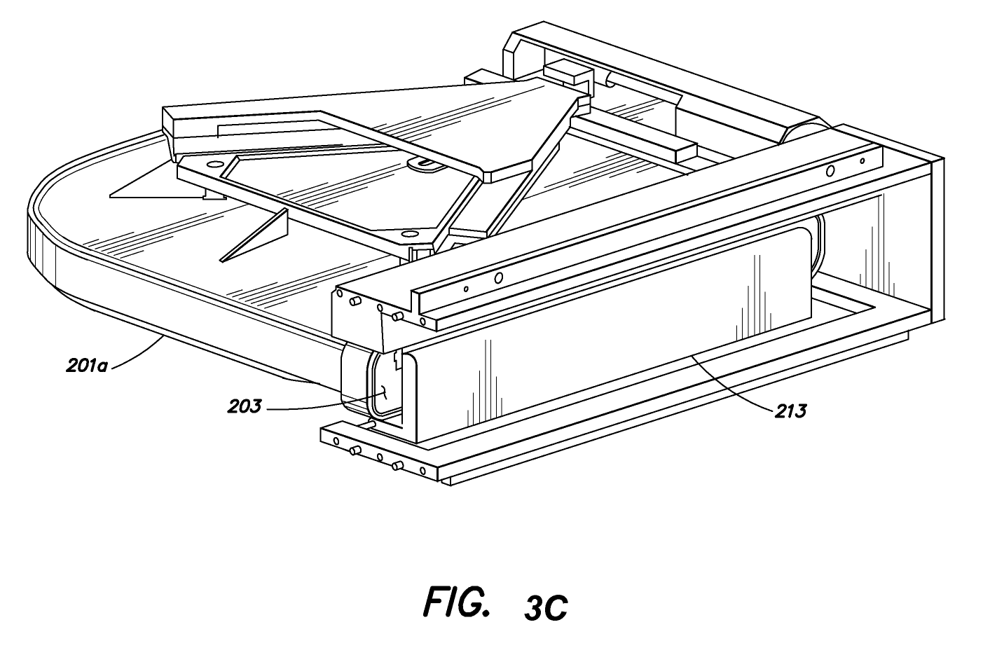

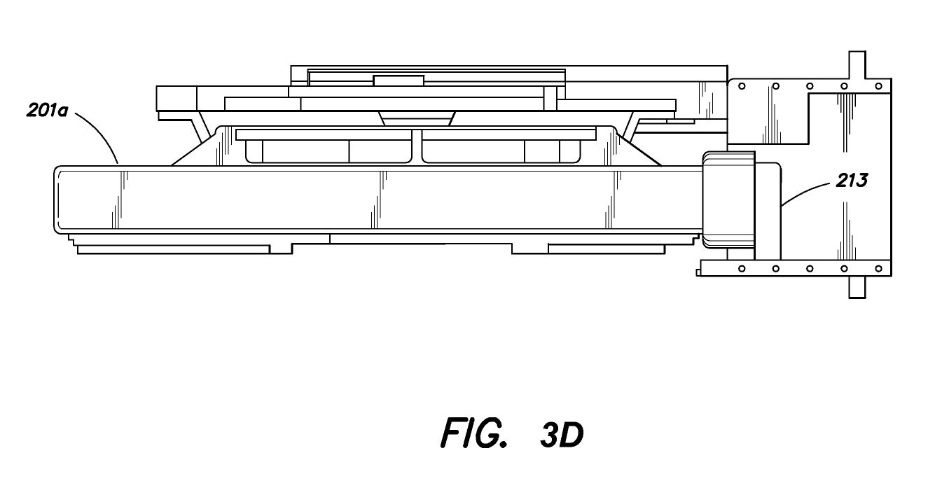

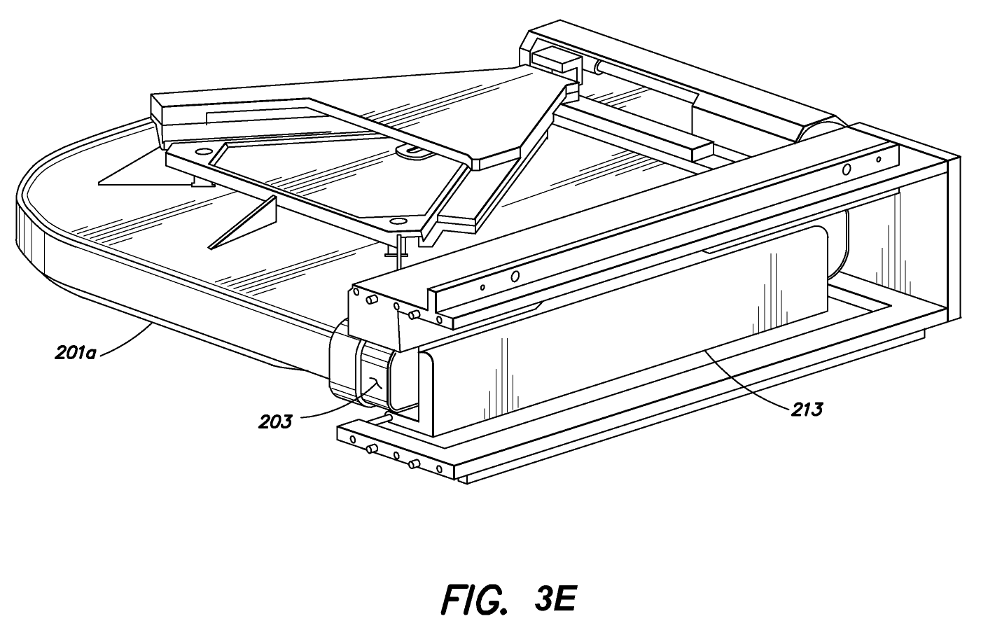

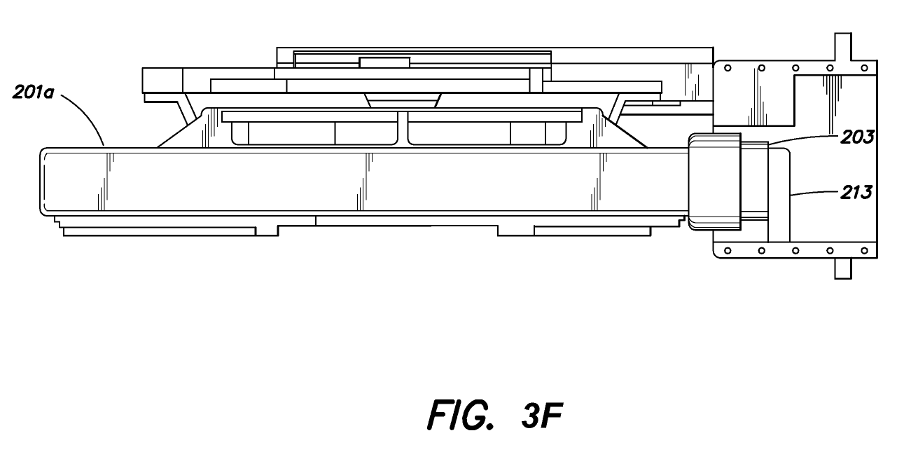

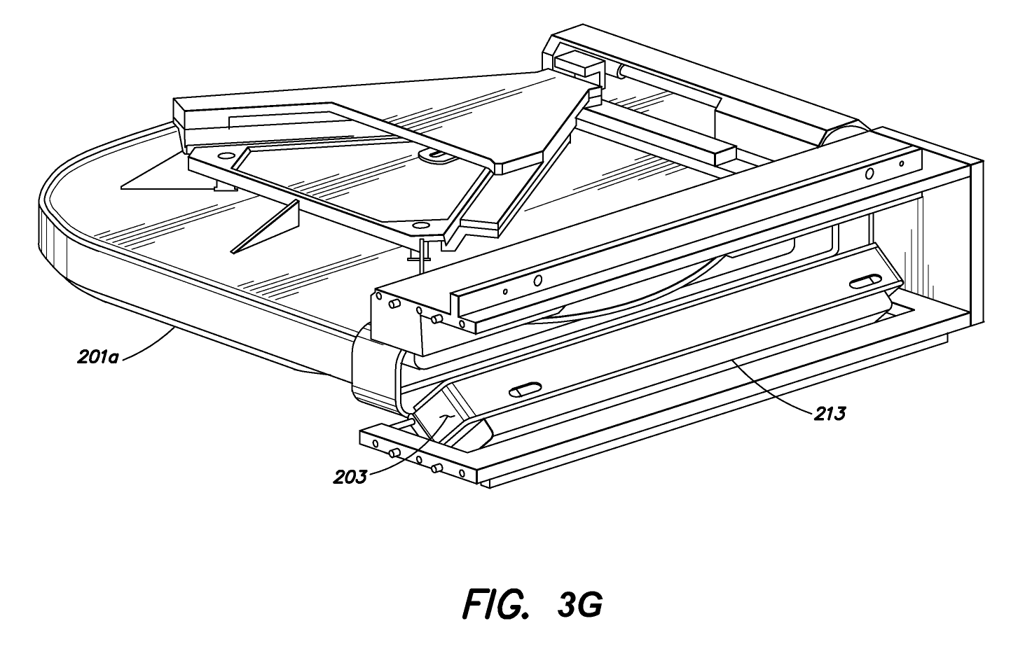

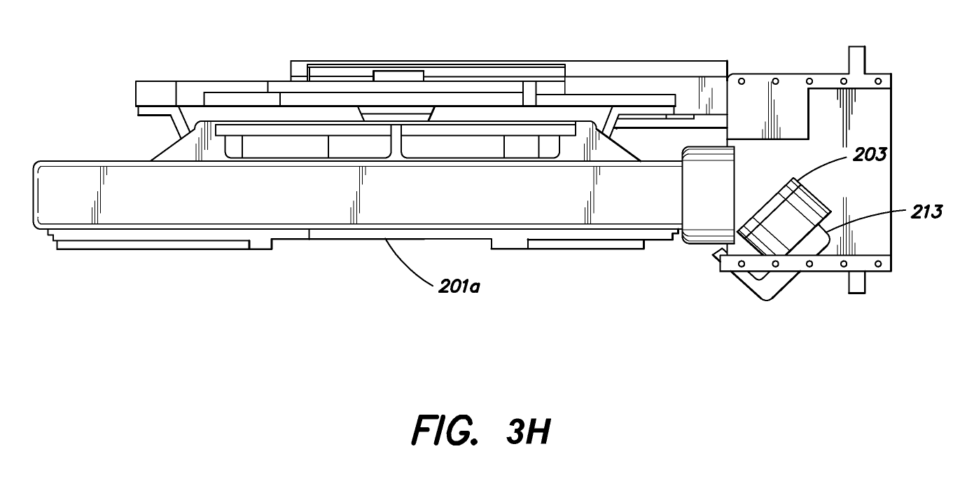

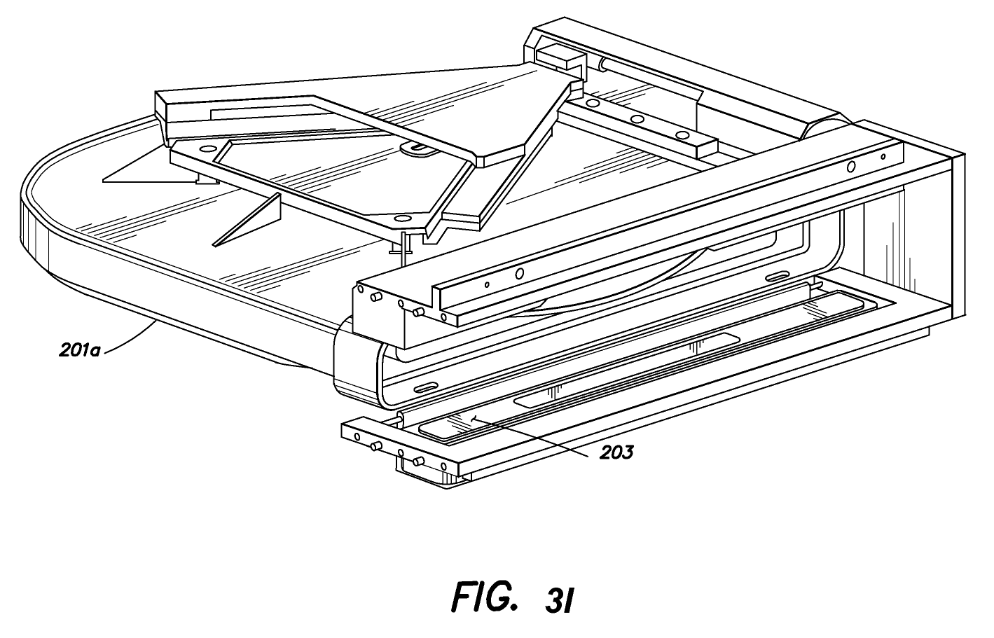

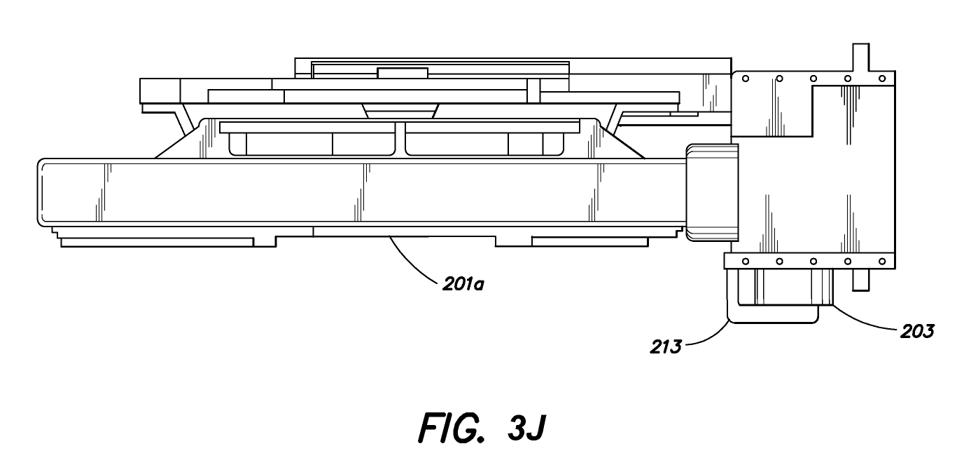

FIGS. 3A-L illustrate a second exemplary embodiment of a door opening mechanism 209′ for opening the door 203 of the substrate carrier 201a. With reference to FIGS. 3A-L, the substrate carrier 201a is supported at a loadport location 211 using the blade receivers 121a, 121b and the overhead transfer flange 113a (e.g., allowing substrate carriers to be stacked with a high packing density). The door opening mechanism 209′ includes a supporting member 213 that is adapted to contact and support the door 203 of the substrate carrier 201a, and pivot the door 203 below the remainder of the substrate carrier 201a as described further below. A linear actuator or other actuator 217 (e.g., a pneumatic, motor driven, hydraulic, etc., actuator) may be employed to dock/undock the substrate carrier relative to the door opening mechanism 209 and/or a loadport 219 of the loadport location 211. The door opening mechanism 209′ of FIGS. 3A-L operates similarly to the door opening mechanism 209 of FIGS. 2A-L, except that the door 203 faces toward the substrate carrier 201a when the supporting member 213 is pivoted downward as shown in FIGS. 3G-L. In such a configuration, the door 203 may be exposed to particles generated during docking/undocking of the substrate carrier 201a.

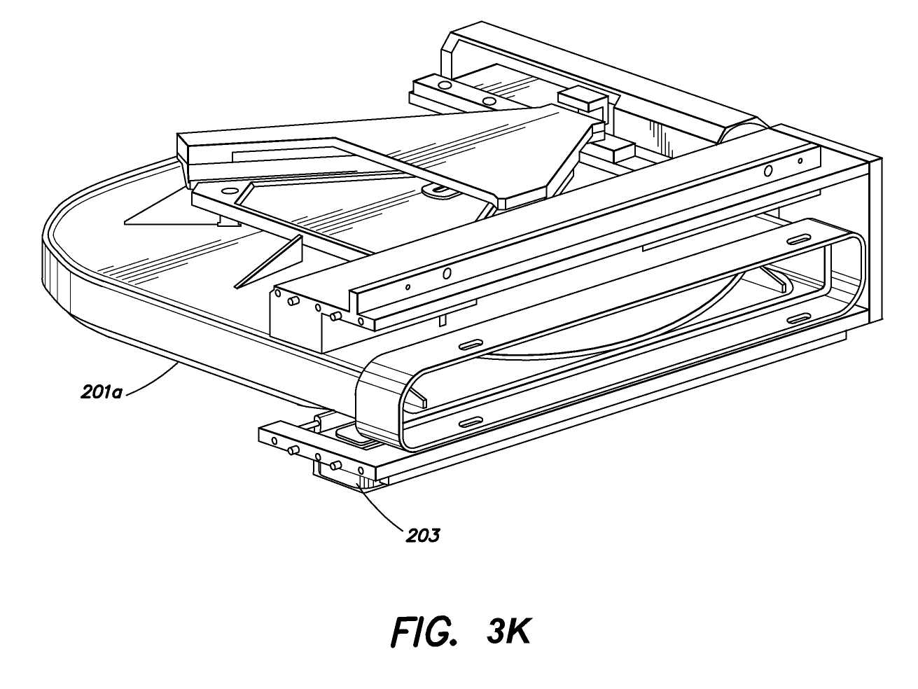

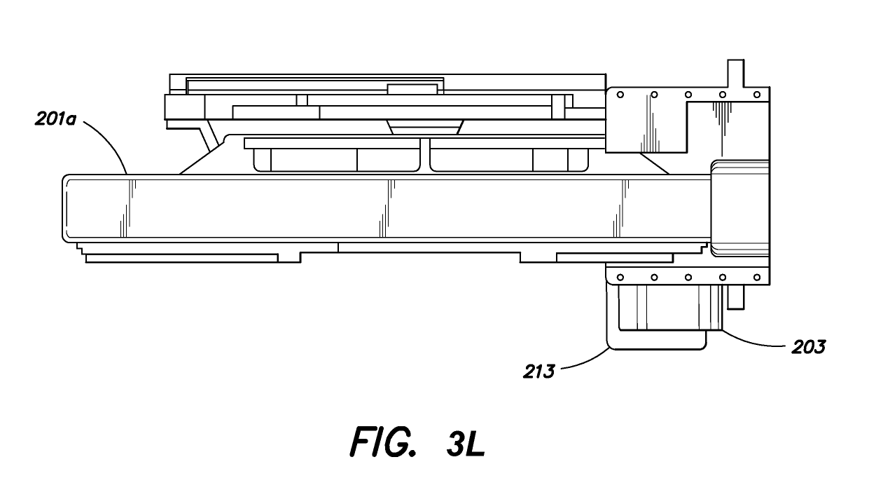

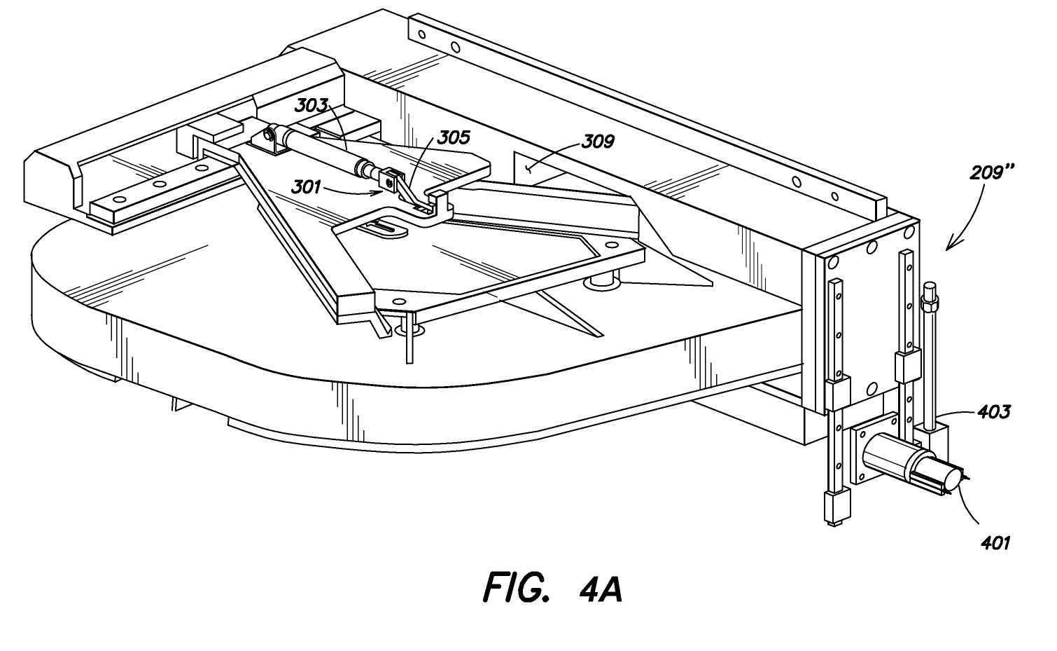

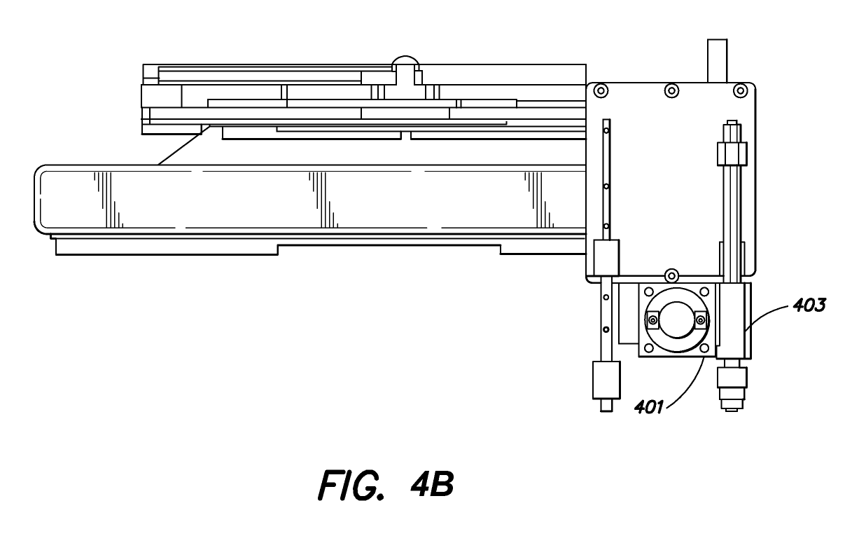

FIGS. 4A-B illustrate a third exemplary embodiment of a door opening mechanism 209″ for opening the door 203 of the substrate carrier 201a. With reference to FIGS. 4A-B, the door opening mechanism 209″ includes a supporting member (not shown) for unlatching and supporting the door 203 (not visible in FIGS. 4A-B) of the substrate carrier 201a (in a manner similar to that described with reference to FIGS. 2A-L and FIGS. 3A-L). However, the door opening mechanism 209″ includes a rotation device 401 (e.g., a motor) adapted to rotate the door 203 about a central axis of the door 203 (and/or about a central axis of the supporting member (not shown); and a linear actuator 403 which is adapted to lower the door (and/or supporting member) down below the substrate carrier 201a. In this manner, the door 203 may be removed, rotated so as to be approximately horizontal and lowered below the substrate carrier 201a. Note that the door 203 may be rotated after it is lowered via the linear actuator 403. In at least one embodiment, the rotation device 401 may move up and/or down with the door 203.

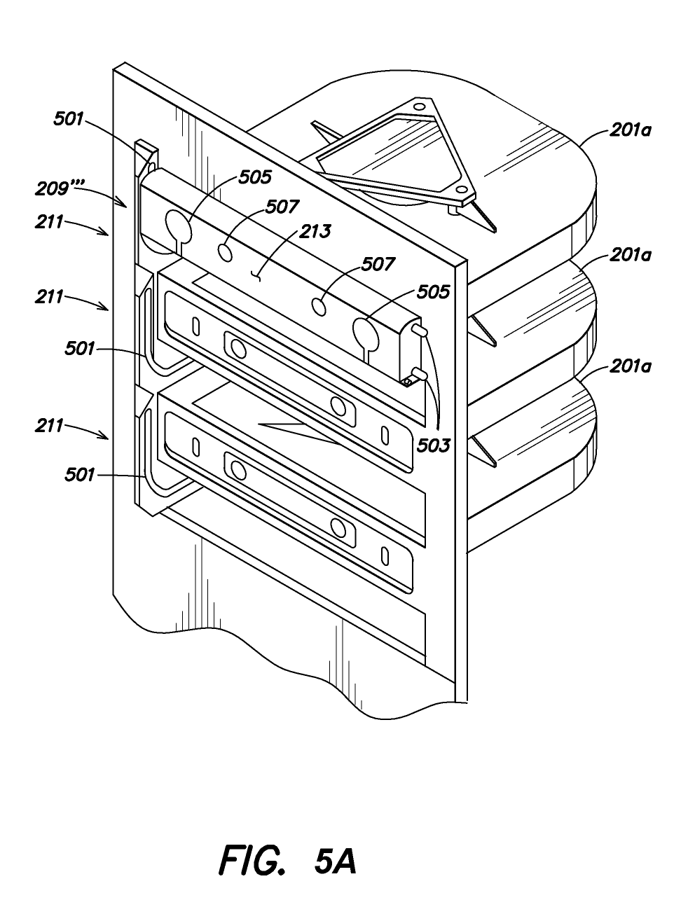

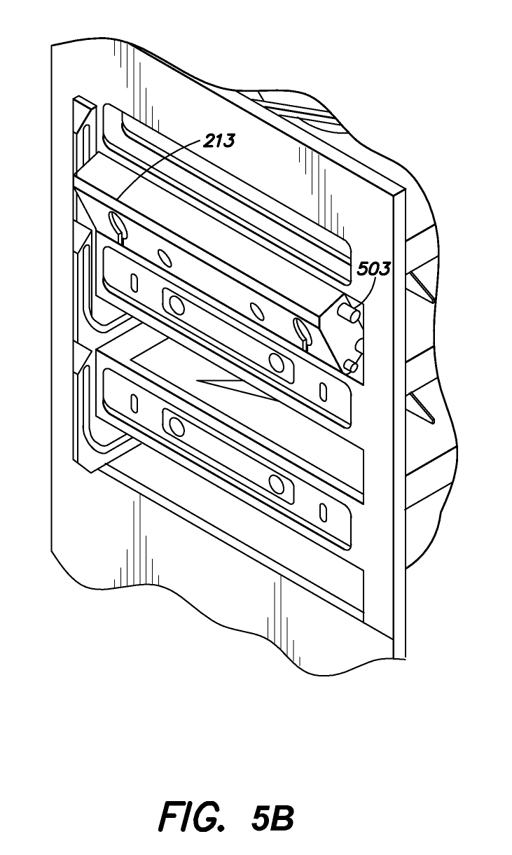

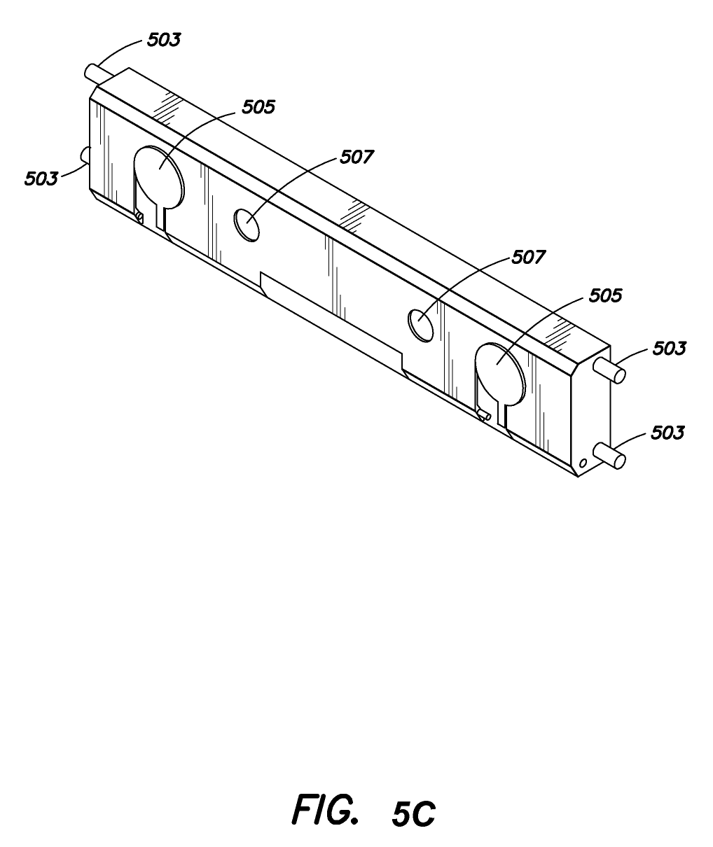

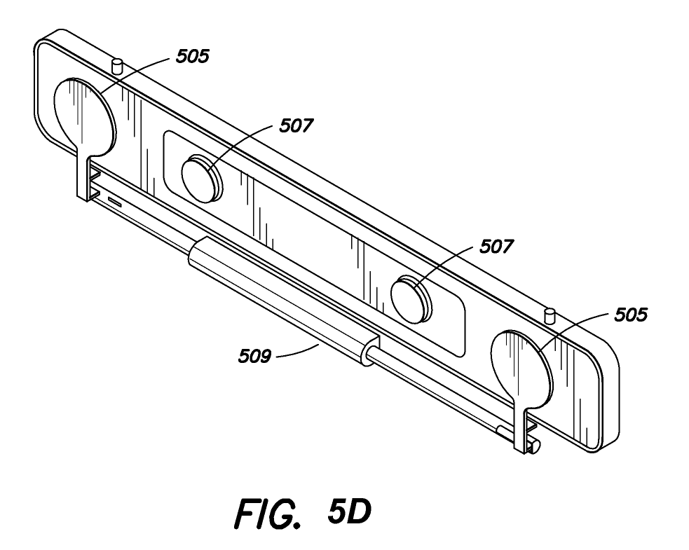

FIGS. 5A-E illustrate a fourth exemplary embodiment of a door opening mechanism 209′″ for opening the door 203 of the substrate carrier 201a. With reference to FIGS. 5A-E, the door opening mechanism 209′″ includes a supporting member 213 that is adapted to contact and support the door 203 of the substrate carrier 201a, and pivot the door 203 below the remainder of the substrate carrier 201a as described further below. One or more sides of a loadport 211 may be provided with a channel 501 (only shown on one side) (e.g., a cam slot) adapted to accommodate one or more features 503 (only shown on one side) (e.g., cam followers) of the supporting member 213. The channel 501 may be employed to lower and pivot the door 203 of the substrate carrier 201a of the remainder of the substrate carrier 201a.

In operation, a substrate carrier 201a is docked into contact with the supporting member 213. In the embodiment shown, unlatching features 505 of the supporting member 213 engage latches of the substrate carrier 201a (described below) and unlatch the door 203. Engaging features 507 (e.g., electromagnets in the embodiment shown) contact and hold the door 203 as the substrate carrier door 203 is moved away from the substrate carrier 201a (FIG. 5A). An actuating mechanism (not shown) then may lower the supporting member 213 and the door 203 below the substrate carrier 201a using the channel 505 and features 503 of the supporting member 213 (FIG. 5B). In at least one embodiment, a linkage 509 (FIG. 5D) may be employed to move the unlatching features 505 simultaneously.

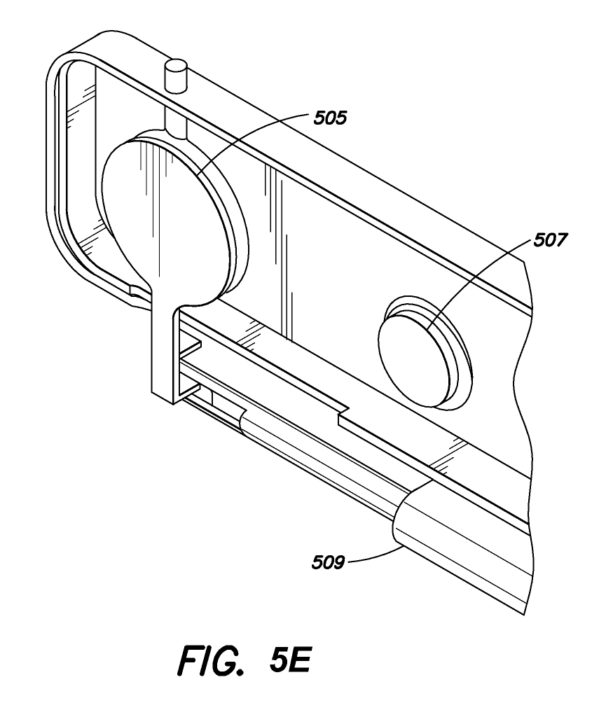

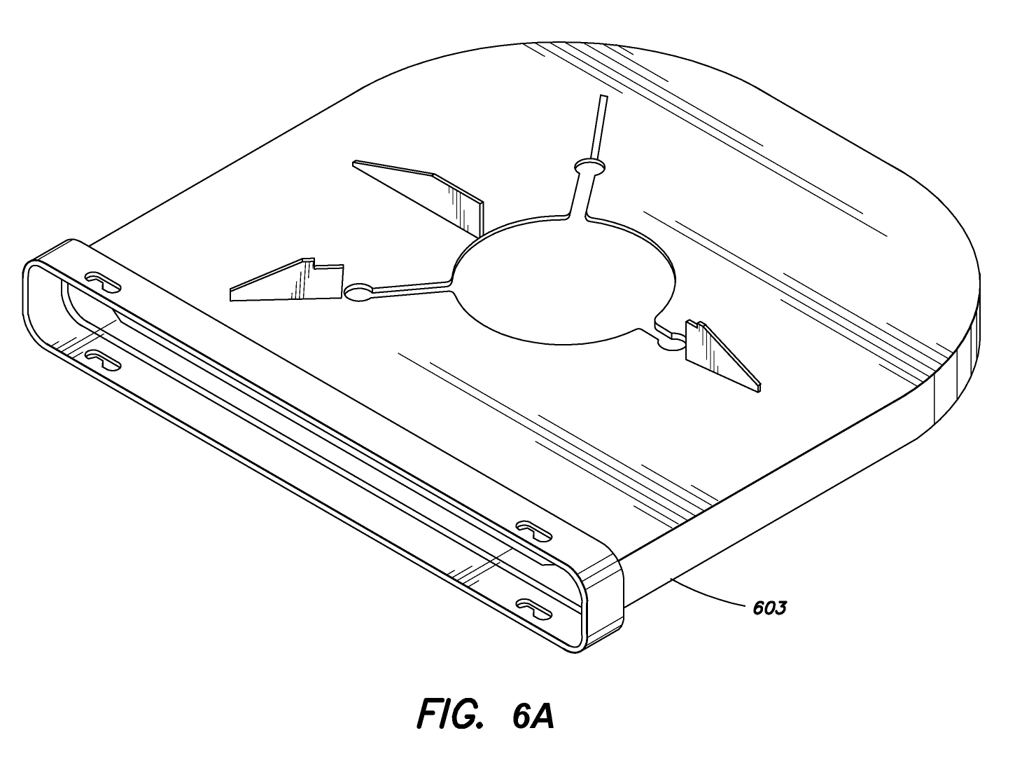

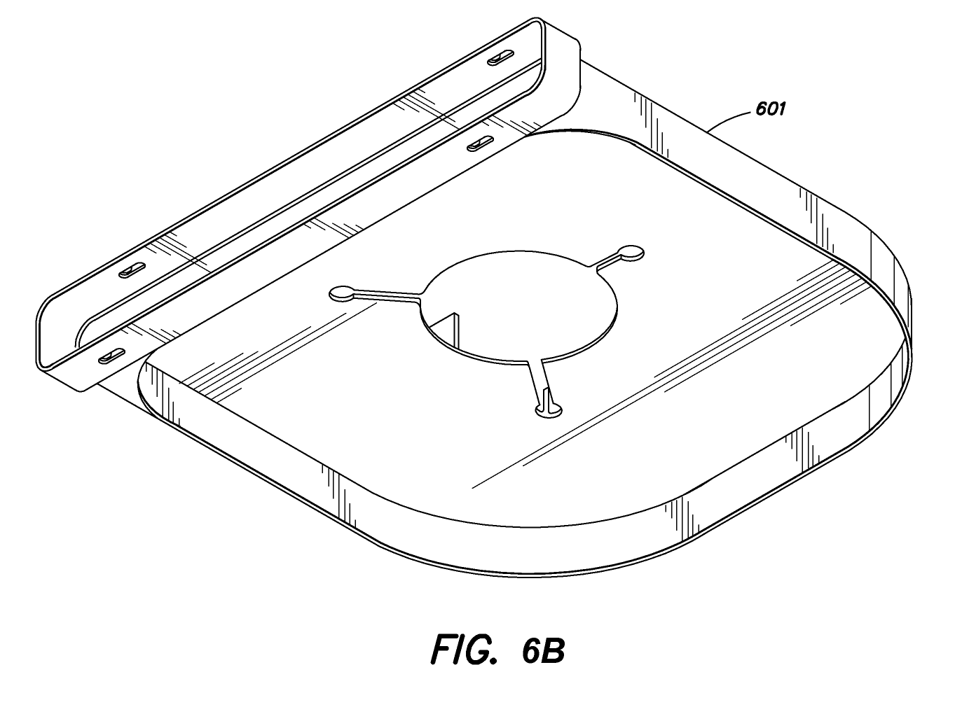

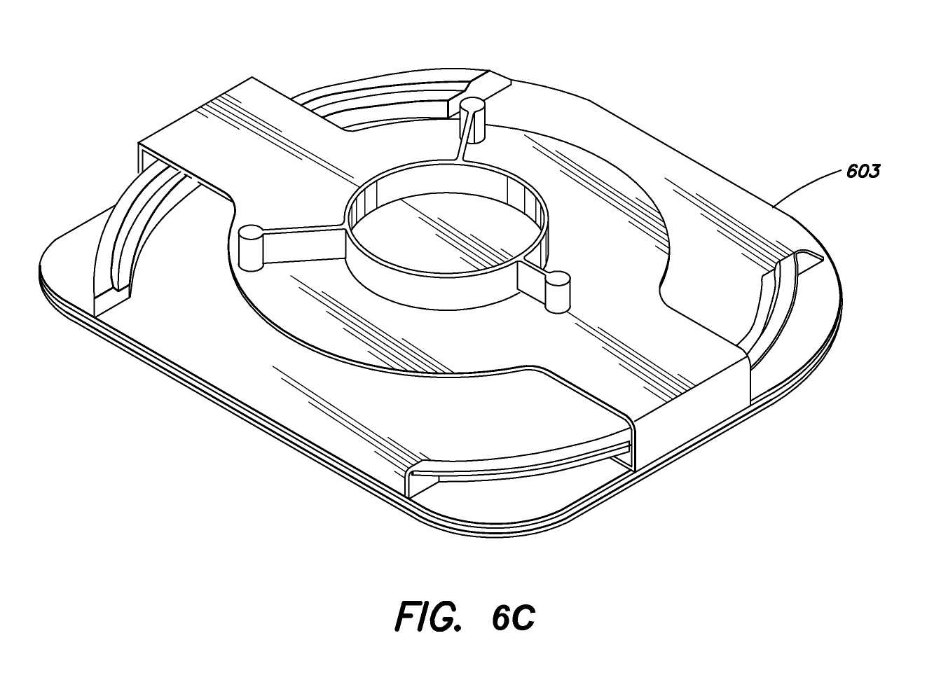

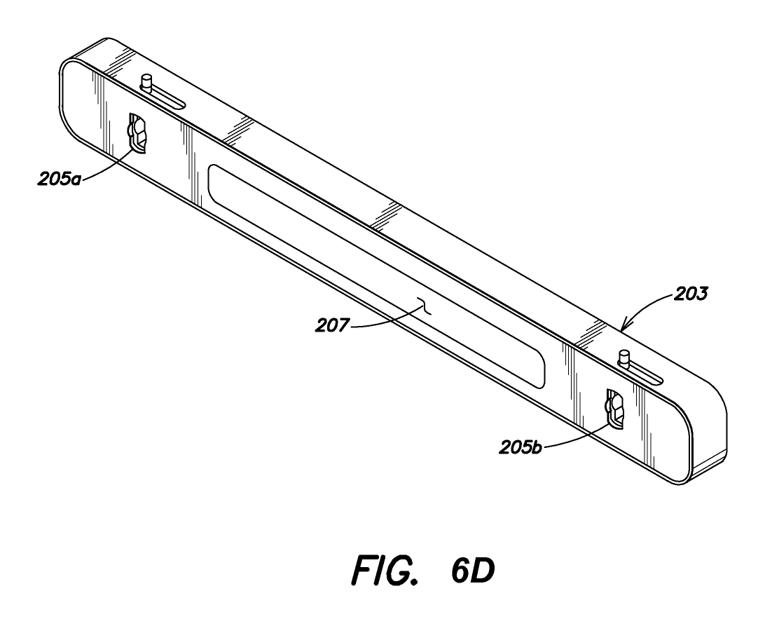

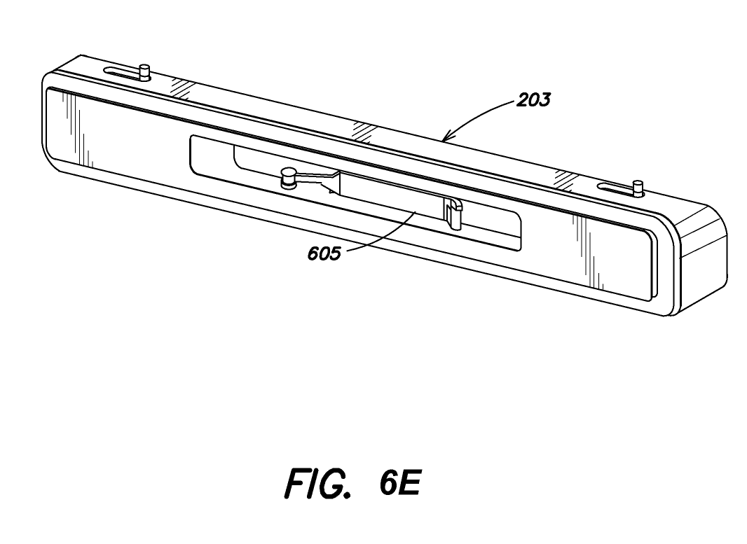

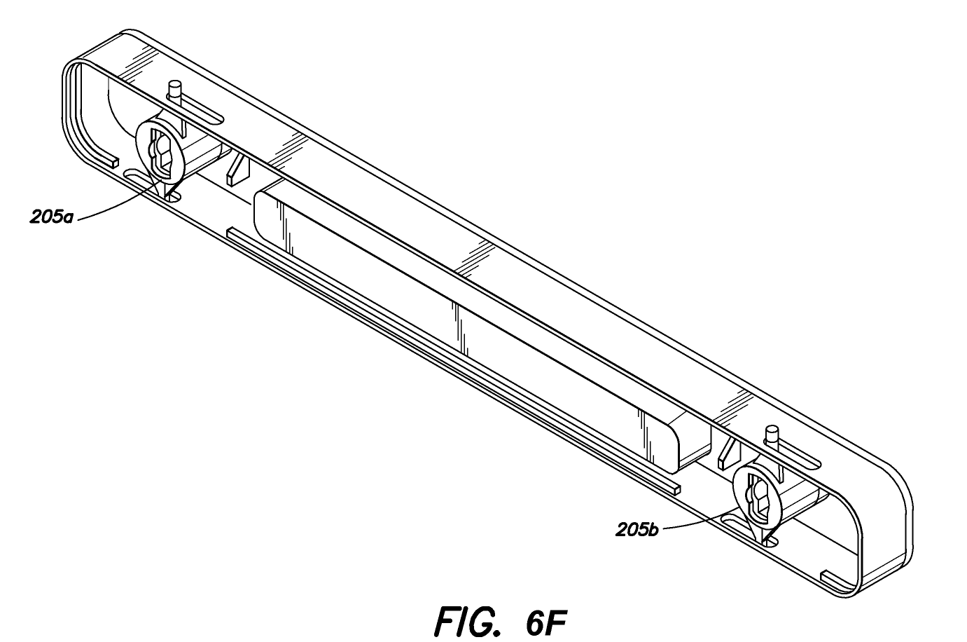

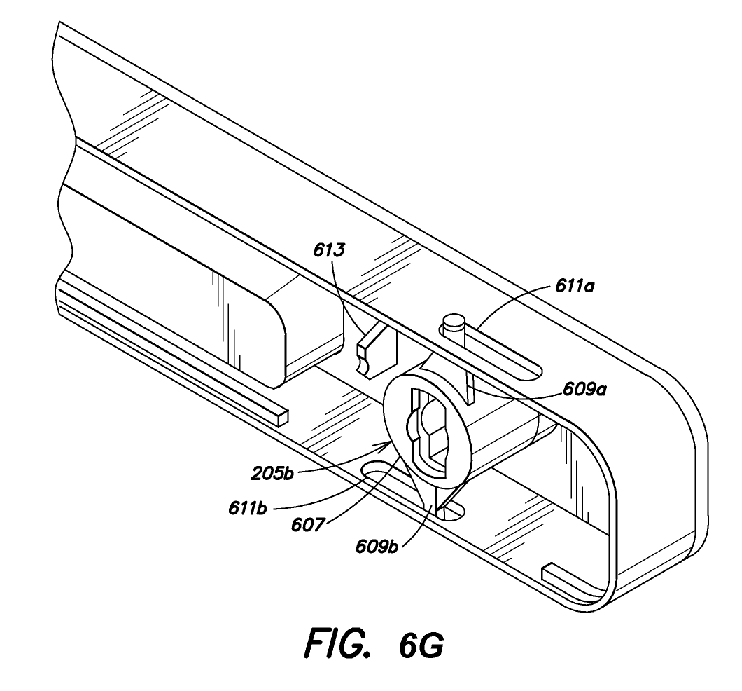

FIGS. 6A-G illustrate various components of an exemplary substrate carrier 201a. With reference to FIGS. 6A-G, the substrate carrier 201a includes a top 601 and a bottom 603. Front and back perspective views of the door 203 are shown in FIGS. 6D-E, respectively. The door includes the latches 205a,b and region 207 described previously, as well as a substrate support member 605 (FIG. 6E) adapted to contact and support a substrate positioned within the substrate carrier 201a when the door is latched thereto.

FIG. 6G is an enlarged portion of the latch 205b. As shown in FIG. 6G, the latch 205b includes a rotary portion 607 that may be engaged and rotated by an unlatching mechanism of a substrate carrier door opener. First and second extensions 609a, 609b of the rotary portion 607 extend radially from the rotary portion and engage guide features 611a, 611b of the substrate carrier 201a. The guide features 611a, 611b may latch (lock) the door 203 in position (e.g., when the extensions 609a, 609b are in the position illustrated in FIG. 6G). To unlatch the door, the rotary portion 607 may be rotated (clockwise in the embodiment of FIG. 6G) such that the extensions 609a, 609b disengage the guide features 611a, 611b. In at least one embodiment, the rotary portion 607 may be rotated by about 90 degrees so that the extension 609a, 609b lie within an approximately horizontal plane. A retaining feature 613 may be provided that engages one of the extensions 609a, 609b so as to hold the rotary portion 607 in a known position. In such a position, the door 203 may be removed from the substrate carrier 201a.

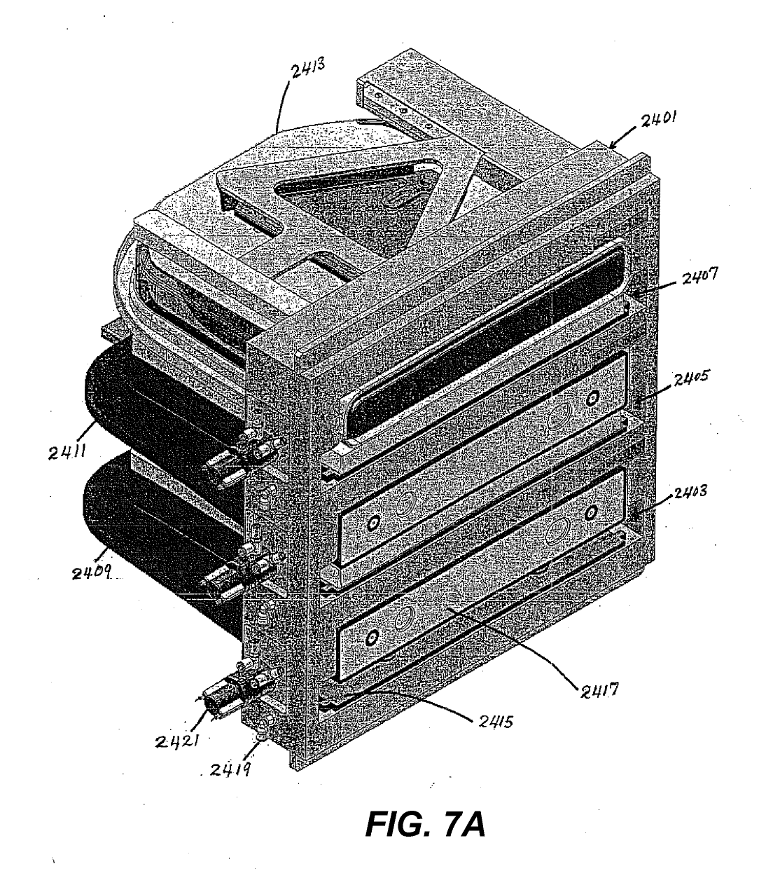

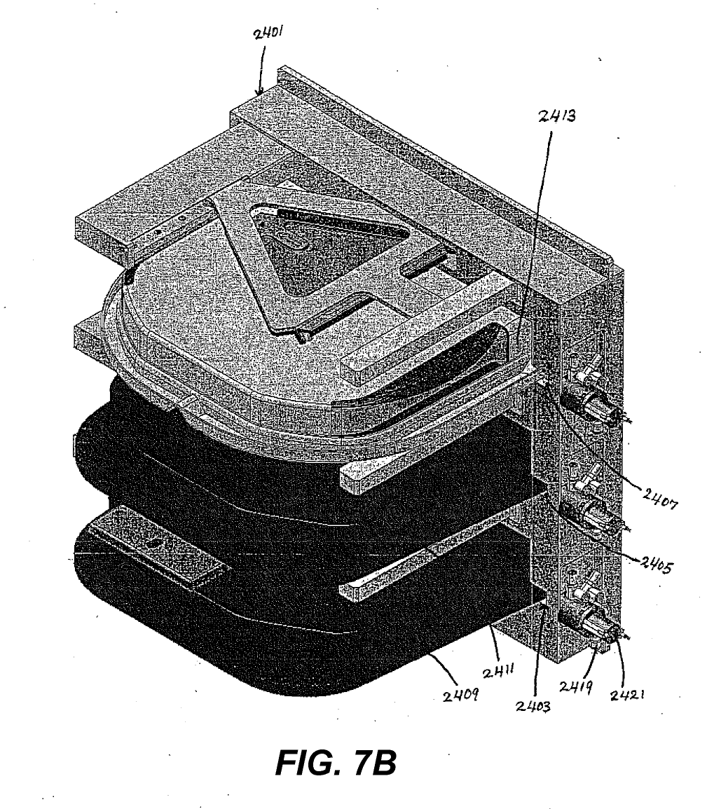

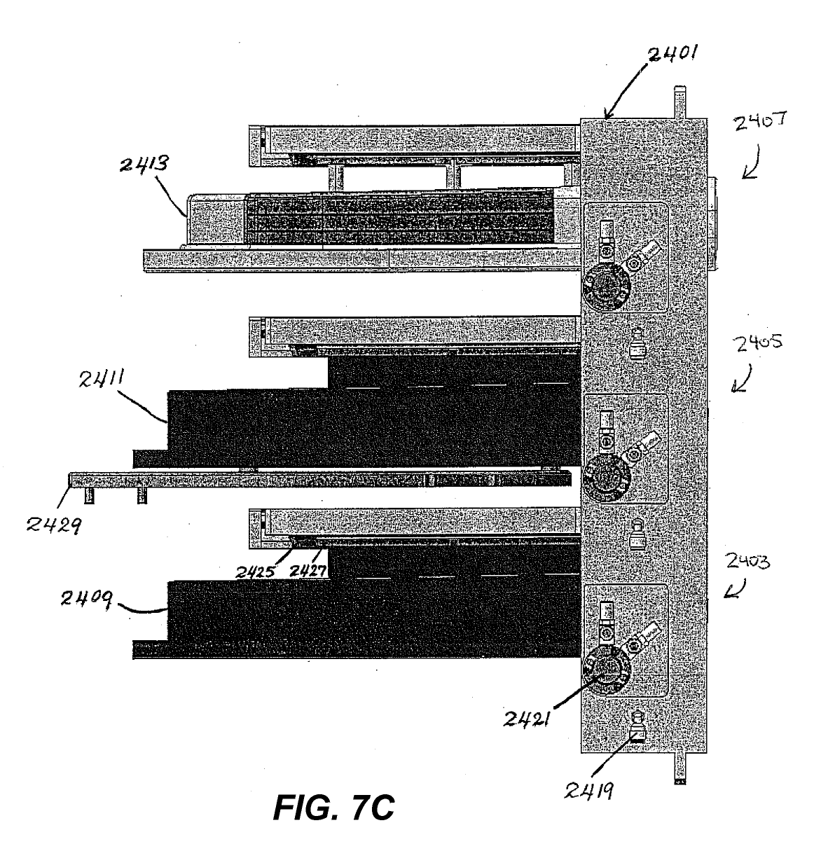

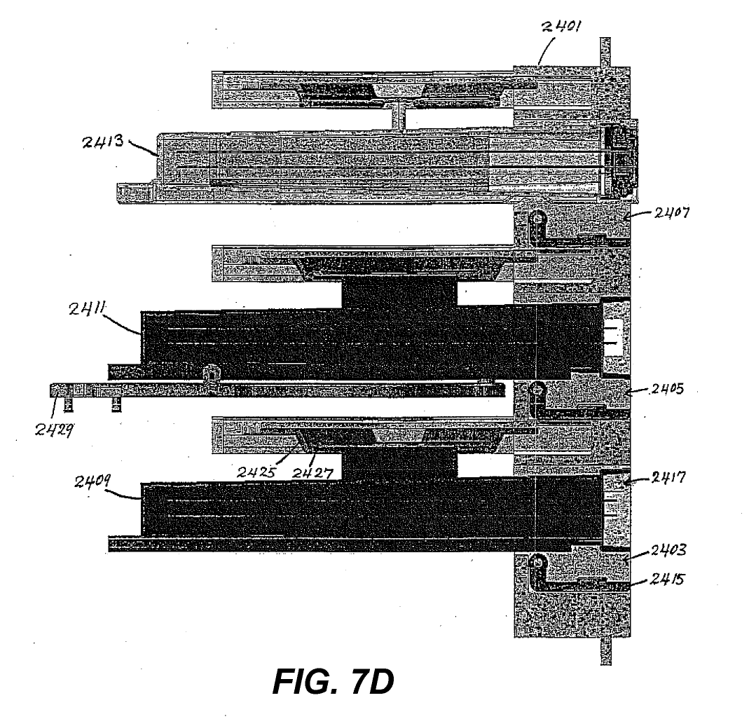

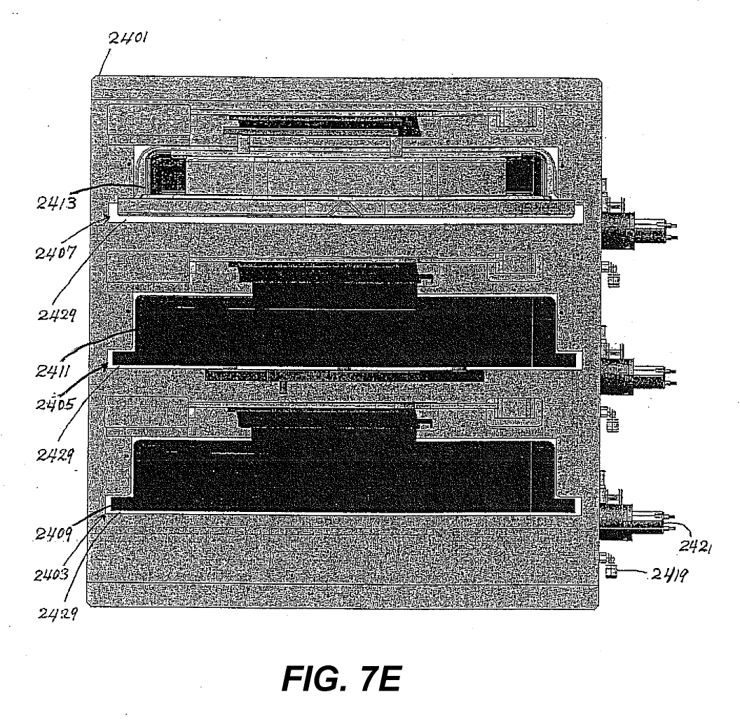

FIGS. 7A-E illustrate an apparatus 2401 for storing a plurality of substrate carriers in accordance with an embodiment of the present invention. With reference to FIGS. 7A-E, the apparatus 2401 includes a plurality of loadports 2403-2407 in a stacked configuration adapted to dock or undock a plurality of substrate carriers 2409-2413. The loadports 2403-2407 may be adapted to dock/undock substrate carriers that store a single substrate or a larger number of substrates. In at least one embodiment, the apparatus 2401 may be dimensioned such that a bottom substrate stored in the substrate carrier 2409 positioned at the lowest loadport 2403 corresponds to the lowest substrate in a 25-substrate substrate carrier and a top substrate stored in the substrate carrier positioned at the highest loadport 2407 corresponds to the highest substrate in a 25-substrate carrier. In this manner, the apparatus 2401 may store a plurality of substrate carriers 2409-2413 in the same space occupied by a conventional 25-substrate substrate carrier. Other loadport spacings may be employed. The structure of the loadports 2403-2407 is similar to the loadport 219 described above, and loadports 2403-2407 support substrate carriers 2409-2413 in a manner similar to that described above.

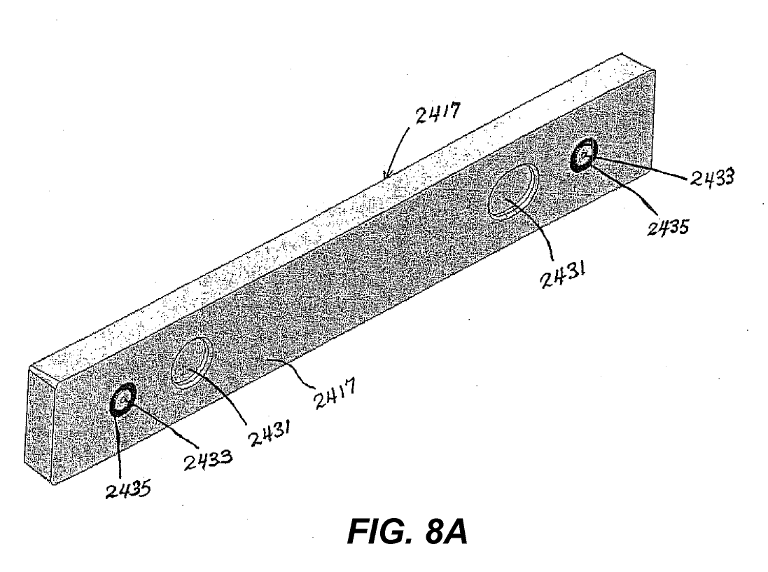

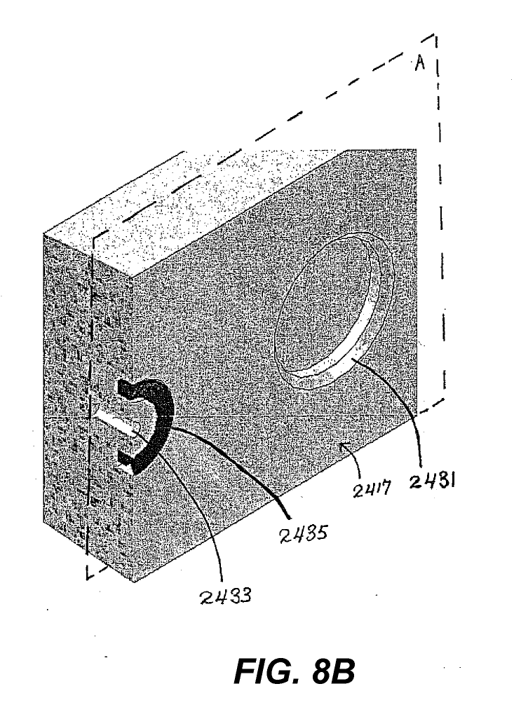

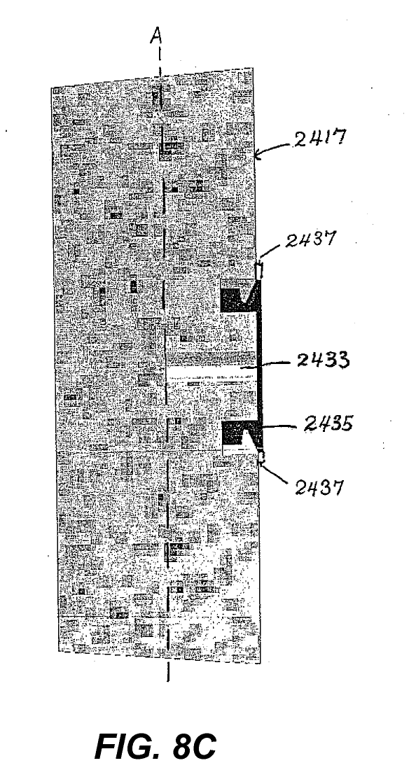

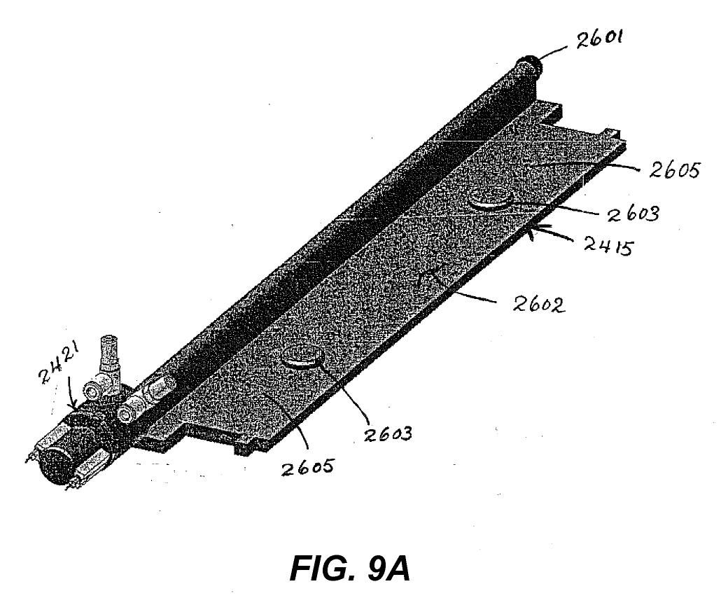

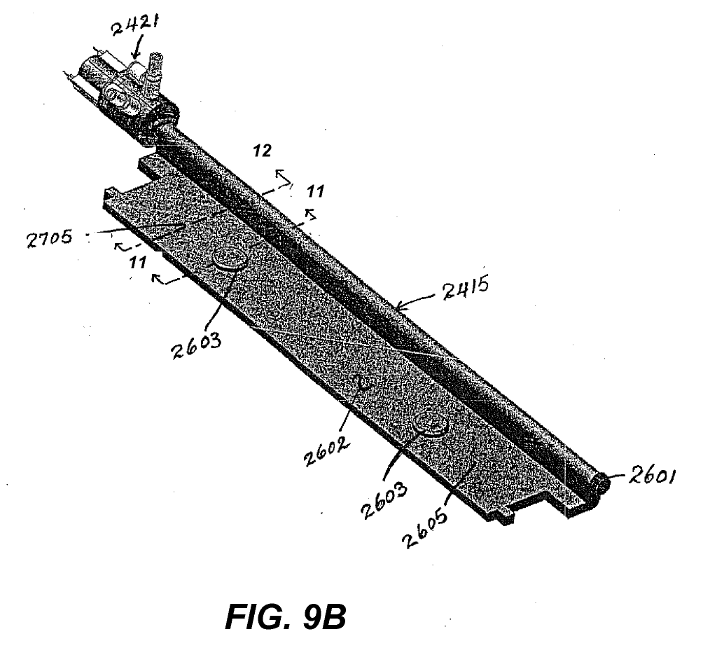

Each of the loadports 2403-2407 includes a door opening mechanism 2415 for removing a substrate carrier door 2417 in accordance with an embodiment of the present invention. The apparatus 2401 includes a fitting 2419 corresponding to and/or coupled to each door opening mechanism 2415. Each fitting 2419 is adapted to provide a vacuum to one of the door opening mechanisms 2415. Further, the apparatus 2401 includes an actuator 2421 corresponding to and/or coupled to each door opening mechanism 2415. Each actuator 2421 (such as a motor or similar actuator) is adapted to rotate a door opening mechanism 2415 as described further below (e.g., from a horizontal to a vertical position or vice versa). Details of the substrate carrier doors 2417 are described below with reference to FIGS. 8A-C and details of the door opening mechanisms 2415 are described below with reference to FIGS. 9A-12.

FIGS. 7C-D illustrate a side view and a cross-sectional side view, respectively, of the apparatus 2401 in accordance with an embodiment of the present invention. With reference to FIGS. 7C-D, similar to the loadport 219 described above, each of the loadports 2403-2407 may include one or more blade receivers 2425 similar to the blade receivers 121a-b described above. Further, each of the substrate carriers 2409-2413 includes an overhead transfer flange 2427 similar to the overhead transfer flange 113a described above. In this manner, a blade receiver 2425 of a loadport 2403-2407 may support a substrate carrier 2409-2413 via an overhead transfer flange 2427. An end effector 2429 may be employed to load the substrate carriers 2409-2413 onto (or unload the substrate carriers 2409-2413 from) the blade receivers 2425 of the loadports 2403-2407.

FIG. 7E illustrates a rear view of the apparatus 2401 in accordance with an embodiment of the present invention. With reference to FIG. 7E, the loadports 2403-2407 may be dimensioned such that when a substrate carrier 2409-2413 is stored in a loadport 2403-2407, a space 2430 is provided between the substrate carrier 2409-2413 and the loadport 2403-2407 that substantially surrounds the substrate carrier 2409-2413. In some embodiments, to maintain a clean environment around the substrate carriers 2409-2413, clean air or another clean gas (e.g., nitrogen, argon, etc.), may be blown downward in front of the apparatus 2401. In such embodiments, a high pressure-region may be created in front of the apparatus 2401. Consequently, clean air may flow through each space 2430 from a front of the loadports 2403-2407 through a rear of the loadports 2403-2407. In this manner, an outer surface of the substrate carrier 2409-2413 may be flushed by such air (or other gas). Particles or other contaminants thereby may be discouraged from entering the substrate carriers 2409-2413 (when the substrate carriers are opened) and/or a processing tool coupled to the apparatus 2401 and adapted to receive substrates therefrom.

FIGS. 8A-C illustrate an exemplary embodiment of the door 2417 of FIG. 7A. With reference to FIGS. 8A-C, the exemplary door 2417 for sealing a substrate carrier 2409-2413 includes one or more features 2431 (e.g., sockets, slots, etc.) adapted to couple to a corresponding registration feature of the door opening mechanism 2415 of a loadport 2403-2407. The features 2431 may ensure proper alignment of the door 2417 with a door opening mechanism 2415 (e.g., via kinematic alignment between the features 2431 of the door 2417 and corresponding features 2603 of a door opening mechanism 2415 described below with reference to FIGS. 9A-B). In one embodiment, the features 2431 may be round or oval-shaped. However, the one or more features may be shaped differently. Although the door 2417 includes two features 2431, a larger or smaller number of features 2431 may be employed.

The door 2417 is adapted to receive vacuum pressure from a door opening mechanism 2415, and in response to the vacuum pressure, release (e.g., unlatch or unlock) from a remaining portion of the substrate carrier 2409-2413 and/or couple (e.g., adhere) to the door opening mechanism 2415. For example, the door 2417 (e.g., an outwardly facing side of the door 2417) may include one or more passageways 2433 for receiving the vacuum pressure. In some embodiments, the passageways 2433 may couple to a bladder (not shown) around a periphery of the door 2417 that is employed to secure or seal the door 2417 to the body of a substrate carrier 2409-2413. In one particular embodiment, the door 2417 may not be removed from the substrate carrier 2409-2413 while the bladder is inflated and may be removed from the substrate carrier 2409-2413 only while the bladder is deflated. Alternatively, the passageways 2433 may lead to a different mechanism (e.g., a different vacuum actuated mechanism) for unlatching or unlocking the door 2417 from the body of a substrate carrier 2409-2413 or the passageway may simply lead towards a central plane A of the door 2417 (FIG. 8C) so as to allow the door 2417 to be held via vacuum by a door opening mechanism 2415.

The door 2417 includes a seal 2435 around (e.g., concentric to) each passageway 2433 for ensuring a vacuum remains in the passageway 2433. A portion 2437 of each seal 2435 may extend from the door 2417. Each seal 2435 may be formed from rubber, another elastomeric material, or any other suitable material. In some embodiments, the door 2417 may include the seals 2435 and thus, the seals 2435 may be more easily replaced than if the seals were present on the door opening mechanism 2415. Nonetheless, one or more seals 2435 may be included in a door opening mechanism 2415.

FIGS. 9A-B illustrate isometric views of a front of a door opening mechanism 2415 in accordance with an embodiment of the present invention. With reference to FIGS. 9A-B, the door opening mechanism 2415 includes a bearing 2601 through which a shaft (not shown) that couples the door opening mechanism 2415 to the apparatus 2401 is inserted. The bearing 2601 enables the door opening mechanism 2415 to pivot with respect to the apparatus 2401 as described below.

A front side 2602 of the door opening mechanism 2415 includes one or more features 2603 (e.g., pads or pins) that correspond to respective features 2431 of the door 2417 (FIG. 8A). The features 2603 are adapted to mate with corresponding features 2431 on the door 2417 to ensure proper alignment of the door 2417 with the door opening mechanism 2415 (and therefore, are dimensioned and shaped accordingly). Although the features 2603 are shown as being round or oval shaped, other shapes may be employed.

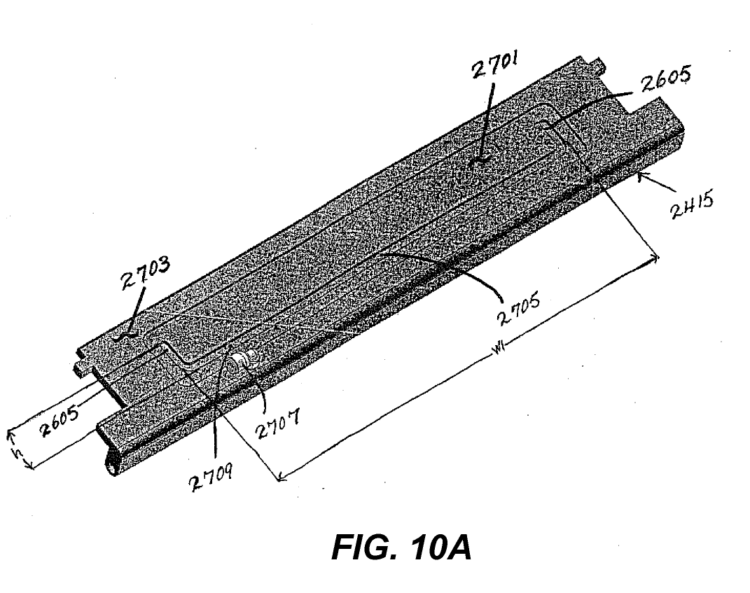

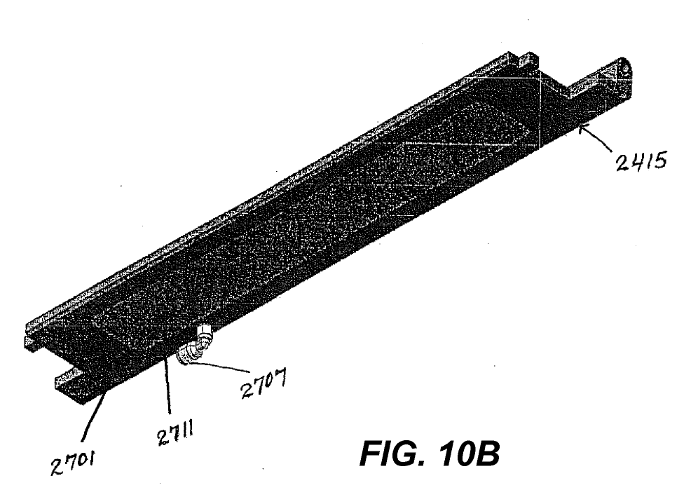

The front side 2602 of the door opening mechanism 2415 includes one or more holes 2605 corresponding to the one or more passageways 2433 included in the door 2417 (FIG. 8A). FIGS. 10A-B illustrate isometric views of a rear of the door opening mechanism 2415. With reference to FIGS. 10A-B, a pocket 2701 may be formed in a rear side 2703 of the door opening mechanism 2415. The pocket 2701 includes a channel 2705 to which the one or more holes 2605 are coupled. The door opening mechanism 2415 includes a fitting 2707 coupled to the channel 2705 via a passageway 2709. The fitting 2707 of the door opening mechanism 2415 may be coupled to a corresponding fitting 2419 (FIG. 7A) of the apparatus 2401 (e.g., for coupling to a vacuum source). A cover 2711 (FIG. 10B) may be coupled (e.g., bonded) to the rear side 2703 of the door opening mechanism 2415, thereby sealing the channel 2705. The cover 2711 and/or the remainder of the door opening mechanism 2415 may be formed from any suitable material. In at least one embodiment, the channel 2705 may form a U-shape having a width w1 and a height h. The channel 2705 may be otherwise shaped.

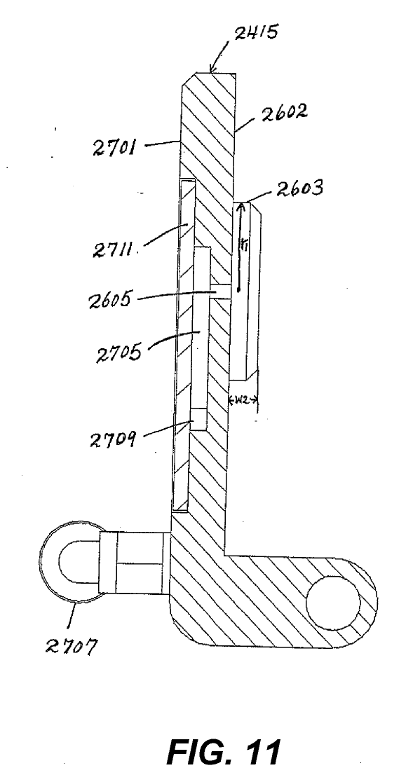

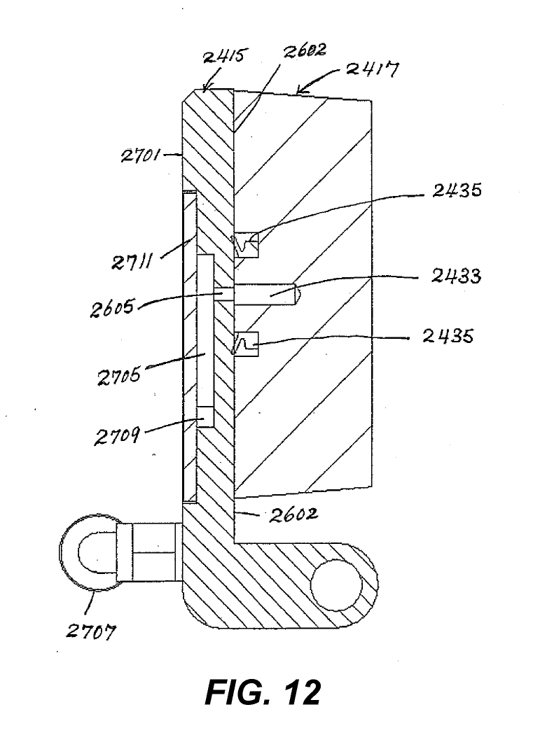

FIG. 11 is a cross-sectional side view of the door opening mechanism 2415 taken along line 11-11 in FIG. 9B. In one or more embodiments, the feature 2603 may have a radius r1 and a width w2. FIG. 12 is a cross-sectional side view of the door opening mechanism 2415 (taken along line 12-12 in FIG. 9B) when the door opening mechanism 2415 is coupled to a substrate carrier door 2417.

In operation, the actuator (not shown in FIG. 12; 2421 in FIGS. 9A-B) may rotate the door opening mechanism 2415 such that the door opening mechanism 2415 couples to (e.g., mates with) the door 2417. More specifically, the actuator 2421 may rotate the door opening mechanism 2415 such that the features 2603 of the door opening mechanism 2415 couple to (e.g., are inserted into) respective corresponding features 2431 of the door 2417, the holes 2605 of the door opening mechanism 2415 align with the passageways 2433 in the door 2417, and the seals 2435 couple to/seal against an area of the front side 2602 of the door opening mechanism 2415 (e.g., concentric to the holes 2605).

While the door opening mechanism 2415 is coupled to the door 2417 of a substrate carrier 2409-2413, a vacuum is provided (e.g., by a vacuum source (not shown)) to the hole 2605 via the fitting 2419 of the apparatus 2401 (and fitting 2707, passageway 2709 and channel 2705 of the door opening mechanism 2415). Consequently, the hole 2605 provides a vacuum to the passageways 2433 in the door 2417 and the door 2417 is held against the door opening mechanism 2415. The actuator 2421 then may rotate the door 2417 out of engagement with its respective substrate carrier body so that the door 2417 is approximately horizontal, lowering the door 2417 (e.g., into a housing) below the respective loadport 2403-2407.

Additionally, in embodiments in which the passageways 2433 are coupled to a mechanism (e.g., vacuum actuated mechanism) for unlatching or unlocking the door 2417 from a remaining portion of a substrate carrier 2409-2413, the vacuum provided by the door actuating mechanism 2415 may serve to actuate such a door unlatching mechanism. For example, the vacuum provided by the door actuating mechanism 2415 (via holes 2605) may serve to deflate a bladder around the periphery of the door 2417, which secures the door 2417 to a body of the substrate carrier 2409-2413 when inflated, thereby allowing the door 2417 to be removed.

The foregoing description discloses only exemplary embodiments of the invention; modifications of the above disclosed apparatus and methods which fall within the scope of the invention will be readily apparent to those of ordinary skill in the art. For instance, the overhead carrier support 111a and the overhead transfer flange 113a may be formed from any suitable material (e.g., materials that slide freely and exhibit long term wear resistance). Exemplary materials for the overhead carrier support and/or the overhead transfer flange include metals (e.g., stainless steel, aluminum, etc.), plastics (e.g., polycarbonate, polyethelene, other ultra high molecular weight or high density plastics, nylon, PTFE, etc.), or other similar materials. Plastic components may be molded or otherwise fabricated. Further, although in embodiments above, a vacuum is provided to the hole 2605 of the door opening mechanism 2415 via the fitting 2419 of the apparatus 2401, fitting 2707 of the door opening mechanism 2415, passageway 2709 and channel 2705, in other embodiments, vacuum may be provided to the hole 2605 through a different route. In some embodiments, vacuum pressure may be used to activate the latches to lock and unlock the door from the substrate carrier.

Accordingly, while the present invention has been disclosed in connection with exemplary embodiments thereof, it should be understood that other embodiments may fall within the spirit and scope of the invention, as defined by the following claims.

The invention claimed is:

1. A system for opening a substrate carrier comprising:
a substrate carrier adapted to hold one or more substrates; and
a loadport for receiving a substrate carrier from a substrate carrier transport system, wherein the loadport includes a door opening mechanism, the door opening mechanism adapted use vacuum pressure to hold a substrate carrier door against the door opening mechanism.

2. The system of claim 1 wherein the door opening mechanism includes a port adapted to apply vacuum pressure from a vacuum source to the door of the substrate carrier.

3. The system of claim 2 wherein the door opening mechanism further includes one or more channels adapted to direct vacuum pressure from the vacuum source to the door of the substrate carrier.

4. The system of claim 1 wherein the door opening mechanism further includes one or more kinematic features adapted to couple with and align the door of the substrate carrier with the door opening mechanism.

5. The system of claim 1 wherein the door includes one or more cup features that are disposed so as to align with the port of the door opening mechanism when the door opening mechanism is adjacent the door.

6. The system of claim 5 wherein the one or more cup features are adapted to create a seal against the door opening mechanism.

7. The system of claim 1 wherein the loadport is further adapted to apply a gas flow around a periphery of the substrate carrier when the substrate carrier is disposed adjacent the loadport.

8. A method comprising:
receiving a substrate carrier at a loadport;
aligning a door opener of the loadport with a door of the substrate carrier; and
applying a vacuum pressure to the door via the door opener to hold the door.

9. The method of claim 8 further comprising applying a gas flow around a periphery of the substrate carrier.

10. The method of claim 8 further comprising removing the door from the substrate carrier.

11. The method of claim 10 further comprising removing a substrate from the substrate carrier.

12. The method of claim 10 further comprising inserting a substrate into the substrate carrier.

13. The method of claim 10 further comprising lowering the door below a level the substrate carrier.

14. The method of claim 13 further comprising raising the door of the substrate carrier to align the door with the substrate carrier.

15. The method of claim 14 further comprising removing the vacuum pressure from the door thereby releasing the door from the door opener.

16. The method of claim 15 further comprising decoupling the door opener from the door of the substrate carrier.

17. An apparatus for use with a substrate carrier comprising:
a loadport including a door opening mechanism, wherein the door opening mechanism is adapted use vacuum pressure to hold a substrate carrier door against the door opening mechanism.

18. The apparatus of claim 17 wherein the door opening mechanism includes a port adapted to apply vacuum pressure from a vacuum source to the door of the substrate carrier.

19. The apparatus of claim 18 wherein the door opening mechanism further includes one or more channels adapted to direct vacuum pressure from the vacuum source to the door of the substrate carrier.

20. The apparatus of claim 17 wherein the door opening mechanism further includes one or more kinematic features adapted to couple with and align the door of the substrate carrier with the door opening mechanism.

21. The apparatus of claim 17 wherein the door includes one or more cup features that are disposed so as to align with the port of the door opening mechanism when the door opening mechanism is adjacent the door.

22. The apparatus of claim 21 wherein the one or more cup features are adapted to create a seal against the door opening mechanism.

23. The apparatus of claim 17 wherein the loadport is adapted to apply a gas flow around a periphery of the substrate carrier when the substrate carrier is disposed adjacent the loadport.
